(19) United States
(12) Patent Application Publication
(10) Pub. No.: US 2018/0101391 A1
(43) Pub. Date: Apr. 12, 2018

(54) SYSTEM FOR CO-ADAPTIVE HUMAN-COMPUTER INTERACTION

(71) Applicant: The Charles Stark Draper Laboratory, Inc., Cambridge, MA (US)

(72) Inventors: Meredith Gerber Cunha, Cambridge, MA (US); Emily Catherine Vincent, Cambridge, MA (US); Zahar Prasov, Cambridge, MA (US); Krysta Elise Chauncey, Cambridge, MA (US); Caroline Elizabeth Harriott, Cambridge, MA (US); Craig Edward Masley, Cambridge, MA (US); Hugh Matthew Enxing, Cambridge, MA (US); Harry Tian Gao, Cambridge, MA (US)

(21) Appl. No.: 15/727,447

(22) Filed: Oct. 6, 2017

Related U.S. Application Data
(60) Provisional application No. 62/405,956, filed on Oct. 9, 2016.

(51) Int. Cl. G06F 9/44

(52) U.S. Cl. CPC G06F 9/4443

(57) ABSTRACT

In an embodiment, a method includes associating a user interaction with a respective command of a library of commands of an application run by a processor. The user interactions are inputted to a graphical user interface (GUI) presented by the application to a user, for example, at a display. The method further includes identifying each of the user interactions with a library of commands of the GUI presented by the application by assigning each user interaction an event identification. The method further includes, in response to one of the event identifications, modifying a dimension of the plurality of user interactions. The method further includes adapting the GUI of the application based on the categorization by presenting command interfaces associated with user interactions predicted by the dimension in the adapted GUI.

### RELATED APPLICATIONS

This application claims the benefit of U.S. Provisional Application No. 62/405,956, filed on Oct. 9, 2016. The entire teachings of the above application are incorporated herein by reference.

### BACKGROUND

Embodiments of the invention relate generally to systems and methods for improving interactivity between a human and a computer. Humans working together adapt to each other in order to accomplish tasks. Active and iterative adaptation by each human improves performance as well as rapport. In human-machine relationships, the human may not fully understand, be aware of, or need to know about each individual capability or feature of the machine; likewise, a machine does not understand every aspect of the human's behavior. Inability of the human and the machine to mutually adapt reduces the effectiveness of their interaction with resulting negative impacts on task completion.

### SUMMARY OF THE INVENTION

In an embodiment, a method includes associating a user interaction with a respective command of a library of commands of an application run by a processor by assigning each user interaction an event identification. The user interactions are inputted the application and displayed by a graphical user interface (GUI) presented to a user, for example, at a display. The method further includes, in response to one of the event identifications, modifying at least one dimension of a model of the user based on the plurality of user interactions with the library of commands via the GUI. The method further includes determining an updated command interface of the GUI based on the modified dimension of the model of the user. The method further includes adapting the GUI of the application by presenting the updated command interface.

In an embodiment, modifying the dimension of the plurality of user interactions further includes clustering the user interactions into the dimension.

In an embodiment, modifying the dimension further includes determining how frequent one of the user interactions occurs, and modifying a frequently used commands dimension. Adapting the GUI of the application further includes presenting command interfaces of the frequently used commands dimension.

In an embodiment, modifying the dimension further includes determining a recency of the user interaction, and modifying a recently used commands dimension. Adapting the GUI of the application further includes presenting command interfaces of the recently used commands dimension.

In an embodiment, modifying the dimension includes determining a user goal for the user interaction, and modifying a goal dimension, and wherein adapting the GUI includes presenting command interfaces associated with the goal.

In an embodiment, determining the user goal includes associating a sequence of the user interactions with a goal.

In an embodiment, the method further includes monitoring interactions with the presented command interfaces in the adapted GUI. The method further includes modifying an adaptation model used to adapt the GUI based on an efficiency score. The efficiency score is based on the use of the presented command interfaces in the adapted GUI. The method further includes basing future adaptations of the GUI on the modified adaptation model.

In an embodiment, the method further includes, based on the user model, providing a message to the application enabling an adaptation widget, adaptation canvas, or adaptation message, wherein the message of the adaptation widget enables the application to present the updated command interface by adding or removing a control of the application, an adaptation canvas provides a designated area within the application to present the updated command interface, and the adaptation message provides instructions for the application to present the updated command interface.

In an embodiment, determining the updated command interface is further based on a user trait of the user model, including user traits indicating need for dynamic content, directive feedback, amount of information presented in the GUI, extroversion, trust, need for cognition (NFC), openness to experience, locus of control, creativity, dispositional trust, neuroticism, resilience to frustration, need for closure, experiential-inductive style, rational-deductive cognitive style, and subjective numeracy.

In an embodiment, a system includes a processor and a memory with computer code instructions stored therein. The memory is operatively coupled to said processor such that the computer code instructions configure the processor to implement a user interface module configured to associate a user interaction with a respective command of a library of commands of an application run by a processor by assigning each user interaction an event identification. The user interactions are inputted to the application and displayed by a graphical user interface (GUI) to a user. The system further includes an adaptation module that is configured to, in response to one of the event identifications, modify at least one dimension of a model of the user based on the plurality of user interactions with the library of commands via the GUI, determining an updated command interface of the GUI based on the modified dimension of the model of the user, and adapt the GUI of the application based on the categorization by presenting the updated command interface.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating an exemplary co-adaptive system according to the present invention.

FIG. 2 is a diagram illustrating an exemplary framework of metrics for the co-adaptive system of FIG. 1.

FIG. 3 is a diagram illustrating a user experience map of an exemplary co-adaptive system.

FIG. 4 is a diagram illustrating an embodiment of a co-adaptive agent according the present invention.

FIG. 5 is a diagram illustrating example domains of technology used by a co-adaptive human computer interface (HCI).

FIG. 6 is a state diagram illustrating example states that a user may be in while using an interface including a co-adaptive human computer interface.

FIG. 7 is a diagram illustrating an example of distributions for testing a co-adaptive HCI.

FIG. 8 is a block diagram illustrating an example embodiment of the present invention.

FIG. 9 is a flow diagram illustrating an example embodiment of a method of the present invention.

FIG. 10 is a block diagram illustrating an example embodiment of a system employing the present invention.

FIG. 11A is a diagram of a graphical user interface employed by an embodiment of the present invention.

FIG. 11B is a diagram illustrating an example embodiment of a graphical user interface employed by the present invention.

FIG. 11C is a diagram illustrating an example embodiment of a graphical user interface employed by the present invention.

FIG. 11D is a diagram illustrating an example embodiment of a graphical user interface employed by the present invention.

FIG. 11E is a diagram illustrating an example embodiment of a graphical user interface employed by the present invention.

FIG. 11F is a diagram illustrating an example embodiment of a graphical user interface employed by the present invention.

FIG. 11G is a diagram illustrating an example embodiment of a graphical user interface employed of the present invention.

FIG. 12 is a block diagram illustrating an example embodiment of a portion of the present invention: a CO-ADAPT module interfacing with a partner application.

FIG. 13 is a block diagram illustrating an example embodiment of the present invention.

FIG. 14 is a block diagram illustrating an example embodiment of the present invention.

FIG. 15 is a table 1500 illustrating an example embodiment of weights used to determine user context.

FIG. 16 illustrates a computer network or similar digital processing environment in which embodiments of the present invention may be implemented.

FIG. 17 is a diagram of an example internal structure of a computer (e.g., client processor/device or server computers) in the computer system of FIG. 16.

### DETAILED DESCRIPTION OF THE INVENTION

A description of example embodiments of the invention follows.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus the term “or” should generally be understood to mean “and/or” and so forth. While this invention has been particularly shown and described with references to example embodiments thereof, it will be understood by those skilled in the art that various changes in form and details may be made therein without departing from the scope of the invention encompassed by the appended claims.

The term “comprises” and grammatical equivalents thereof are used herein to mean that other components or steps are optionally present. For example, and article “comprising components A, B, and C can consist of (i.e., contain only) components A, B, and C, or can contain not only components A, B, and C but also one or more other components.

The present invention is directed to systems and methods that satisfy the need for improved interactivity between a user and a computer. Embodiments of a co-adaptive agent according to the present invention feature the ability to change its behavior over time in response to a dynamic understanding of an individual human collaborator. Such an agent may be able to scope and prioritize the information presented to a human if it is able to adapt to the human collaborator's needs over time. Embodiments of the present invention feature a framework for metrics to guide co-adaptive agent behavior as well as methods for one such metric and assessing the resulting co-adaptive system. An example of the framework is hierarchically organized by three sources of adaptation variability, having nine dimensions that are further subdivided into facets of adaptation. Based on the dimensions, the framework can provide adaptations to a user interface of an application. The adaptations, when applied to the user interface, provide a user interface to the user better suited to the user's traits, task, or other criteria as described below.

As machine technology advances, human-machine teams are accomplishing increasingly complex tasks. In human-human relationships, as the team performs a task, each person adapts to the other as well as to the task over time. Human teamwork does not require each person to have an exhaustive knowledge of other individual contributors' skills; instead, active and iterative adaptation on both parts improves performance as well as rapport. In human-machine relationships, the human may not fully understand, be aware of, or need to know about each individual capability or feature of the machine; likewise, a machine does not understand every aspect of the human's behavior. A co-adaptive agent may be able to scope and prioritize the information presented to a human if it is able to adapt to the human collaborator's needs over time.

In the field of user interfaces, including graphical user interfaces (GUIs), current systems offer manual flexibility to adapt their user interface by users. For example, current software allows a user to independently adjust settings to customize a layout of a user interface by adding or removing controls for certain features, or by moving controls to different physical areas of the user interface. However, this takes the user time and effort, and in addition, the user has to know in advance the feature he or she is aiming to add or remove from the user interface.

Some current software can offer search engines for their features. These command recommender systems can further offer different search results based on a search history or use of feature history, but do not offer the ability to change the user interface. Rather, the command recommender systems only offer the ability to recommend a particular function based on a search or past user interactions.

Further, current adaptive interfaces offer information based on an input parameter, but do not offer layout customization. Similarly, some current tutoring software provides self-adjusting tutoring, which adjusts provided content, such as vocabulary level, or knowledge level for standardized tests, but is domain restricted to those specific areas of knowledge.

Other software includes intelligent assistants, such as Apple's® Siri and Amazon® Echo. These systems provide Natural Language Understanding and respond to specific requests from a user, but do not adjust the layout of a user interface.

Recommender systems, employed by content providers like Netflix®, social media providers like Facebook®, or electronic commerce websites such as Amazon®, can recommend media, content, and products to a user based on past user interactions and user traits. However, these systems only provide recommendations based on query or history, and do not provide any layout customization or response personalization based on user traits.

Therefore, there is no current system that offers layout customization for a user interface based on user traits and user interaction. Further, no system offers layout customization based on mixed initiative intelligence.

Therefore, there is a need for a co-adaptive human computer interface (HCI). With current user interface design, users often employ a small set of the available features in the default user interface. The overlap between features needed by a user and the default features set can be minimal. Many users don't take advantage of the ability to customize the software because (1) they don't know how to do so, (2) they don't know that additional features are available, or (3) customizing the user interface is too burdensome. A co-adaptive HCI can solve these problems by maintaining the utility of high-feature software to large groups of users by providing default settings that are suited for most people, while allowing the ability to automatically improve usability for individuals. The co-adaptive HCI changes its rules over time in response to a dynamic understanding of each individual user. Then, the co-adaptive HCI presents the user with an amount of information that is appropriate for the user, task, and context. Throughout the application, the co-adaptive HCI can be a graphical user interface that a user interacts with.

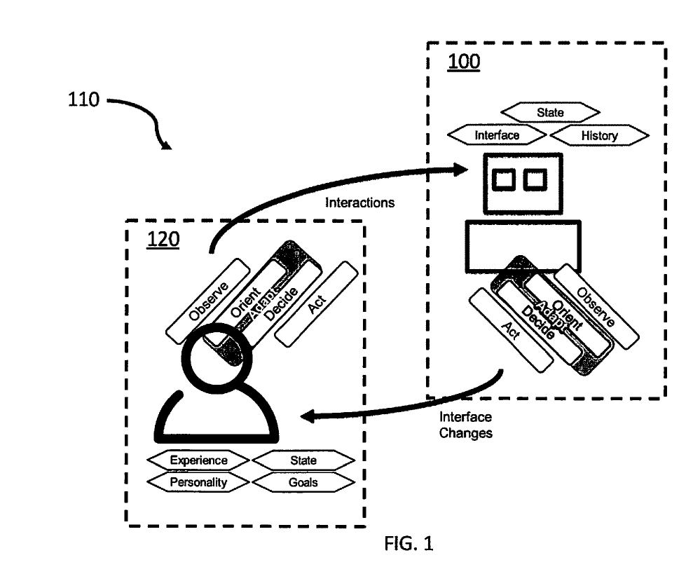

Referring to FIG. 1, in embodiments, a co-adaptive agent 100 refers to an entity within a co-adaptive system 110, where the system is the combination of an operator 120 and an agent 100. A co-adaptive agent 100 can modify its behavior over time in response to a dynamic understanding of an individual human collaborator. FIG. 1. illustrates an exemplary co-adaptive system 110 having a feedback loop in which a co-adaptive agent 100 interacts with and adapts to a human operator 120, who, in turn, adapts to the agent 100.

The agent 100 may be implemented as an embodied robotic, tangible, or software platform. Advantageously, a co-adaptive agent 100 differs from a conventional adaptive agent in that it adapts to the human collaborator over time as the human interacts with and adapts to the agent. Since the technology and the user iteratively adapt to each other over time, co-adaptive technology can be thought of as technology that adapts to the operator in the moment.

Creating a co-adaptive relationship between the human and machine allows for each entity to respond to the other while adapting to each other and the tasks at hand. Work in the human-machine interaction literature has identified the need for, and methods of, adapting the machine's behavior to the human collaborator. In embodiments, a co-adaptive agent may employ a framework for metrics to guide co-adaptive machine behavior as well as methods for one such metric and thoughts on assessing the resulting co-adaptive system. In addition to the human-machine context, a co-adaptive system can also adapt a graphical user interface to the user's goals, personality traits, experience, and history of interactions.

A co-adaptive agent uses information about the individual human collaborator in order to adapt; the following sections describe embodiments of co-adaptive agents and an exemplary framework of metrics to guide the adaptive behavior.

Adaptation is a term that is used by robotics, human-machine interaction, and other intelligent systems communities. However, there is no standard taxonomy to describe the dimensions of adaptation. It is common to find a term with different meanings and different terms for similar concepts. A hierarchical framework may be used to describe the dimensions of adaptation; the most fine-grained elements of this hierarchy can be automatically identified and quantified by a computational agent. Different dimensions of adaptation of a co-adaptive HCI are described below.

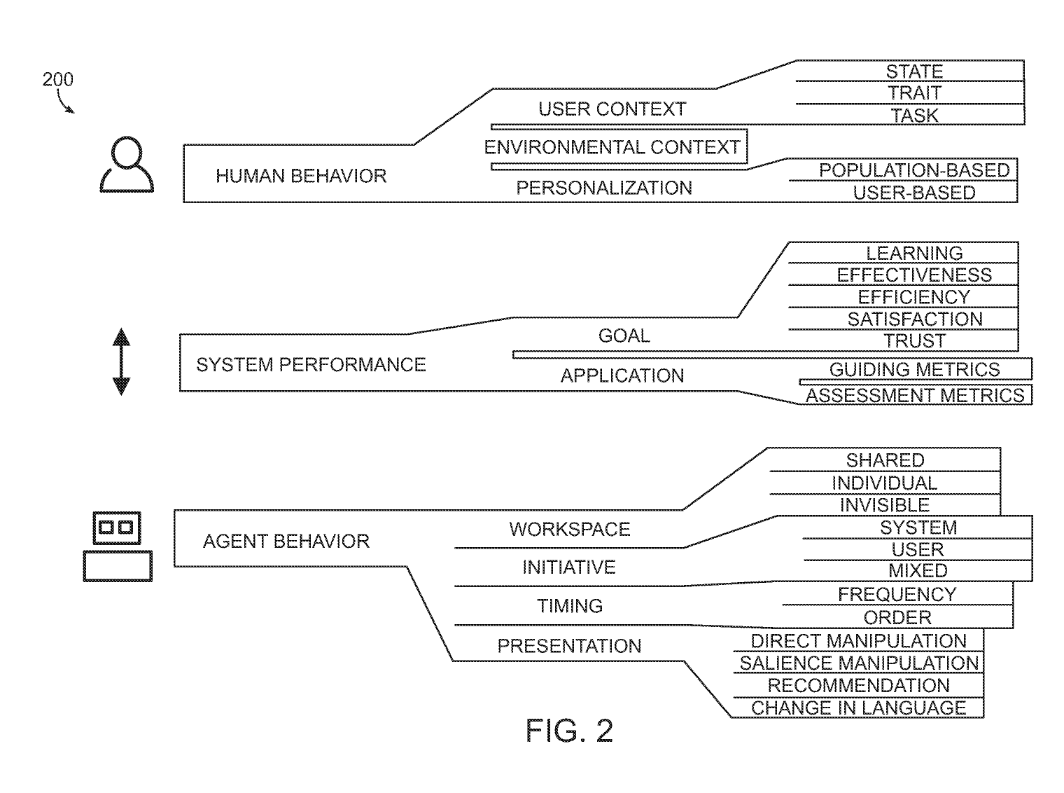

FIG. 2 illustrates embodiments of three sources of variability that characterize agents that are capable of mutual and iterative adaptation. These dimensions of adaptation include human behavior, agent behavior, and metrics that govern this behavior. FIG. 2 illustrates a framework 200 for metrics of co-adaptive human-machine (e.g., graphical user interface, robot) interaction. Human behavior, observed by the human-machine interaction, serves as input to the agent providing information that can be used to determine the appropriate adaptation strategy. The adaptation strategy is manifested as agent behavior, which serves as output to the user via the agent interface. Various metrics prioritize and filter the human and agent behavior as well as provide quantifiable assessment of the benefits of adaptation.

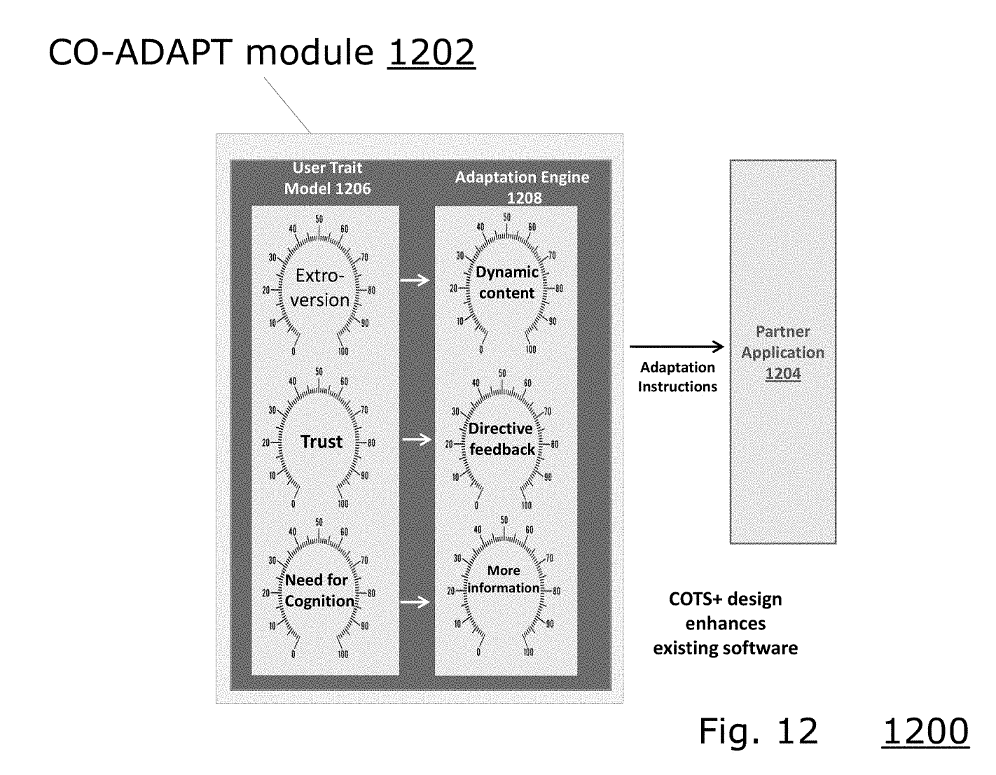

In embodiments, a user model describes or represents user context, environmental context, and personalization. The user model can represent information determined about the user through the user's use of the application. User context consists of trait, state, and task, as shown in FIG. 2. A trait, such as openness to new experience, is a largely invariant (or very slowly variant) observable human characteristic. A state, such as frustration or cognitive load, is a fleeting user characteristic that occurs in response to the human-machine interaction or other temporal factors. A task is a sequence of activities with defined goals and operational constraints which a user has undertaken. The user context is a function of a weighted sum of trait, state, and task: UC=f(X*trait+Y*state+Z*task). Each trait is correlated with a type of adaptation in the adaptation model, as shown in further detail in FIG. 12. While FIG. 12, illustrates three particular traits, other types of traits can exist. In one embodiment, there are ten traits that translate to ten different adaptation factors. The ten traits include need for dynamic content, directive feedback, amount of information presented in the GUI, extroversion, trust, need for cognition (NFC), openness to experience, locus of control, creativity, dispositional trust, neuroticism, resilience to frustration, need for closure, experiential-inductive style, rational-deductive cognitive style, and subjective numeracy.

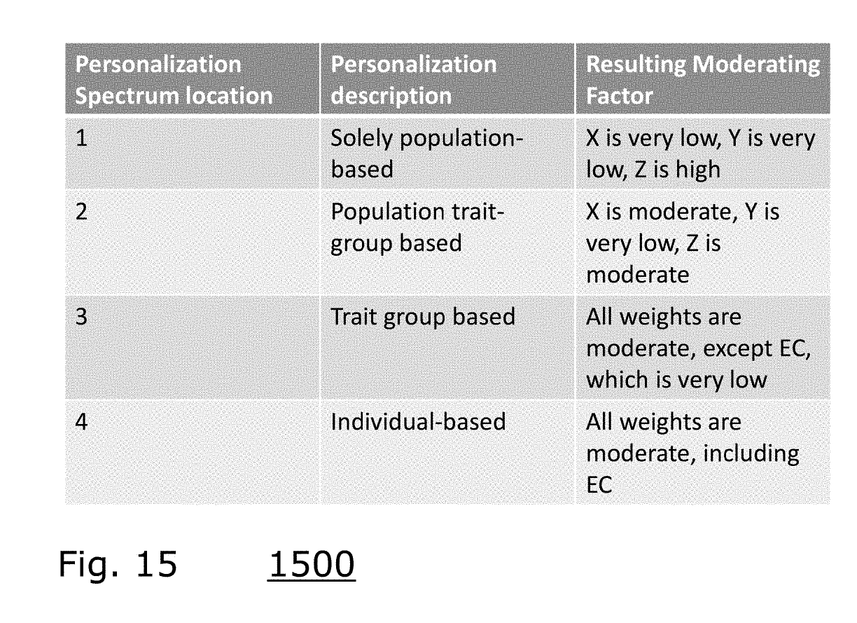

The user model is a function of user context which is moderated by environmental context and personalization: UM=f(UC, EC, P). FIG. 15 illustrates further factors of how personalization moderates the user model. The user context and user model can further be considered collections of data collected about the user, or the user, environment, and personalization contexts, respectively. The adaptation model employs the user context and user model to generate adaptations to the user interface.

A user state and task can be modelled. Usage patterns of users can be observed and modeled. User productivity further can be inferred by tool use, and shared state spaces can be found across users using big data analysis tools. In addition, the user's state can be estimated based on his or her tool use. Further, analysis can correlate tool use with certain tasks.

Environmental context provides user-independent information about the operational environment. For example, precise location information provided by a GPS unit does not depend on a user's history or prior behavior; an adaptive agent would behave in the same manner with this information regardless of any characteristics of the human collaborator.

Personalization refers to the degree to which the adaptation is individualized and how the specific attributes of users' interaction (e.g. task frequency, search vernacular, etc.) is modeled. The two ends of the spectrum are user-based, designed to determine the characteristics of a specific human collaborator, and population-based, designed to determine characteristics relating to how a generic user interacts with the adaptive agent. The primary distinction is the resolution of modeling and the time needed to observe a user before being able to make acceptably accurate inferences for adaptation.

In embodiments, the user (or agent) interface dimension refers to the manner in which the interface adapts and responds to the user behavior. This dimension includes the collaborative workspace, initiative, timing, and presentation.

Human-machine interaction and adaptive behavior can occur in a shared workspace, an individual workspace for each collaborator, or behind the scenes with no visible workspace. An individual workspace, for example, the one used by Kiva robots, allows each contributor to work on a component of the work product, allowing the user to ignore the machine's contributions until they are deemed relevant and useful. Conversely, in a shared workspace, each collaborator may contribute to a single work product, which forces the human to respond to the agent behavior immediately when the interaction occurs. Examples of a shared workspace include research on human-machine cross-training, where the human and machine collaborators are working together to complete a task in the same physical space, same user interface, or shared user interface reproduced across multiple machines. Some adaptations can occur without any visible workspace. For example, the agent may pre-load certain data based on the user interaction, resulting in faster response times without affecting any response content.

An individual interaction may be initiated by a human user or the agent. Agents that primarily initiate adaptive behavior are considered to employ system initiative, while agents that allow a user to dictate when an adaptation occurs are considered to employ user initiative. Mixed initiative agents exhibit both types of behavior.

The timing dimension can consist of frequency and order. Frequency governs how often (in terms of order of magnitude) the agent adapts its behavior. Adaptation can occur in real-time, one or two times within a single session, or occasionally across sessions. Order refers to the temporal position of the attempted adaptation strategies. For example, an agent may give the user a directive only if an ignored recommendation has resulted in diminished performance.

The presentation dimension refers to the actual manifestation of the adaptation. An agent may directly manipulate the user's graphical user interface or emphasize the most salient aspect of the workspace. The agent may avoid any direct manipulation, and rather provide the human collaborator with a recommendation or alter the controls displayed in the graphical user interface.

In embodiments, metrics, such as metrics measuring the human behavior, system performance, and agent behavior shown in FIG. 2, may be used to quantify user behavior and govern useful adaptation. In order for co-adaptive agents to adapt usefully, the agent can measure and take the user's task or goal into account to select the appropriate adaptation strategy. In addition, the system performance of the agent can be measured in a metric to determine whether the adaptations are useful to the user. Quantifiable metrics may be used to assess and compare adaptation strategies and different adaptive agents. Adaptation metrics can be categorized into two dimensions: goal metrics and application metrics.

Goal metrics, such as learning, effectiveness, efficiency, satisfaction, and trust may be used to determine whether an adaptation strategy is successful. For example, a machine adapting its behavior to provide detailed explanations could be considered beneficial if learning or trust are prioritized over efficiency, but detrimental if efficiency is prioritized. Further, use of a particular combination of tools can be analyzed as being part of achieving a goal.

Application metrics consist of two facets: guiding metrics and assessment metrics. Guiding metrics are used to drive the co-adaptive agent adaptations, while assessment metrics are used to evaluate the success of the adaptations and compare different agents and adaptation strategies. It is preferable, but not required, that the same goal metrics are applied for guiding and assessment of adaptation.

In embodiments, co-adaptive agents 100 are informed by monitoring metrics of human behavior and task performance that can guide the appropriate adaptation for the state of the agent as a whole at the moment. Metrics may be used to assess the advantages of co-adaptive agents 100 over non-co-adaptive agents. An advantage could be in one or more of several dimensions (or categories): learning, effectiveness, efficiency, satisfaction, and trust. A metric (i.e., an aspect of the system to measure) and a baseline (i.e., something to which to compare the co-adaptive agent) may be used in assessing an advantage. Metrics can serve to guide the adaptation or to assess the adaptation, and some may be suitable for doing both. For example, cognitive load could serve as both if an agent adapted to lower cognitive load when it rose in the course of a task, and also used the average cognitive load to determine whether or not that adaptation was successful after the fact.

An example of a metric in the facet of trust is buy-in, which may be defined as a weighted average of dispositional, situational, and learned trust as available. A common formulation for measuring trust in automation is based on a user's reliance on the automation, which cannot be assessed in the absence of use. Buy-in is an example of a trust metric. Buy-in does not replace trust as a whole but instead subdivides it, allowing an operator to recognize the utility of an adaptation even though it may not be appropriate, necessary, or in force at the moment. Tracking buy-in explicitly or modeling it from behavior, as part of an operator model (e.g., as a user model), allows an agent to respond conditionally to different states on the part of the operator.

An awareness of buy-in provides co-adaptive agents with a parameter by which to judge the appropriate level of confidence in adaptations. That is, when an operator is in a state of high buy-in, it may be less damaging to present an adaptation with a lower confidence level than if that operator is in a state of lower buy-in. It may also allow for the representation of trust recovery after agent errors or poorly-received adaptations.

Referring to FIG. 2, in various embodiments of a co-adaptive system 110, buy-in can serve multiple purposes. For example, in modeling user state (also known as operator state), buy-in may be measured in real-time during the user's interaction with the agent, and inform the behavior of the co-adaptive agent 100. In other examples, buy-in measured during the human-agent interaction can be used as a guiding metric, informing agent behavior. Buy-in may also be used as an assessment metric and used to compare multiple systems' performance. In still other examples, the agent 100 can manipulate the timing of alerts on the basis of user buy-in state. An exemplary co-adaptive agent 100 may modify presentation to the user 120 on the basis of buy-in. For example, in response to known buy-in of user 120, the agent 100 can change the salience or style of interventions and recommendations to improve system performance.

Buy-in can be measured using a protocol based in psychometrics, wherein participants are asked to specify how much they would pay to acquire or to avoid a particular co-adaptation on the part of the agent. This indicates how useful participants think the adaptation in question would be, but within-subject normalization is required to control for individual differences in scale of value.

To normalize these values, participants choose one experience from a short list of experiences at four levels of scale; for example, in a non-user interface context and at the smallest level of scale, representative choices are skipping a short line, or disposing of a noisome insect. At each level of scale, participants are asked to mark what currency value they would give for their chosen experience on a Visual Analogue Scale. This allows normalization within and across subjects as well as consistent framing across items within subjects.

Co-adaptive systems 110 may incorporate models for one or more of the three major sources of system variability: the human behavior, the agent behavior, and their interaction, governed and quantified by system metrics. Embodiments of a co-adaptive agent 100 according to the present invention feature a structure for identifying appropriate metrics that relate to each of these sources of variability.

Presently existing systems can distinguish between guiding and assessment metrics, organize a metrics framework on the basis of what is adapting, and measure buy-in as a guiding adaptation metric. The present invention builds off these concepts and further distinguishes between guiding and assessment metrics and incorporates considerations for co-adaptation, unlike conventional approaches to metrics frameworks in human-machine interaction. Additionally, embodiments of the co-adaptive agent 100 include a metrics framework organized based on what is adapting, which also distinguishes it from conventional approaches. A co-adaptive agent 100 that measures buy-in can shape the behavior of a human-machine team, which may improve team performance. Buy-in as a distinct measure from trust may provide the machine with the ability to identify behaviors that are more successful before the collaborator has bought in (e.g., demonstrating higher transparency in the reason for taking actions) and afterwards (e.g., presenting recommendations or taking actions with a lower confidence level in their appropriateness). If measuring the state of buy-in allows the machine to present more diverse ideas to a higher likelihood of acceptance by the human collaborator, the co-adaptive relationship, and team performance, may improve. Diverse ideas are shown to improve team performance, but this result has not yet been demonstrated in human-machine collaborative teams. Not all of the foregoing advantageous features or all of the advantages need be incorporated in every embodiment of the invention.

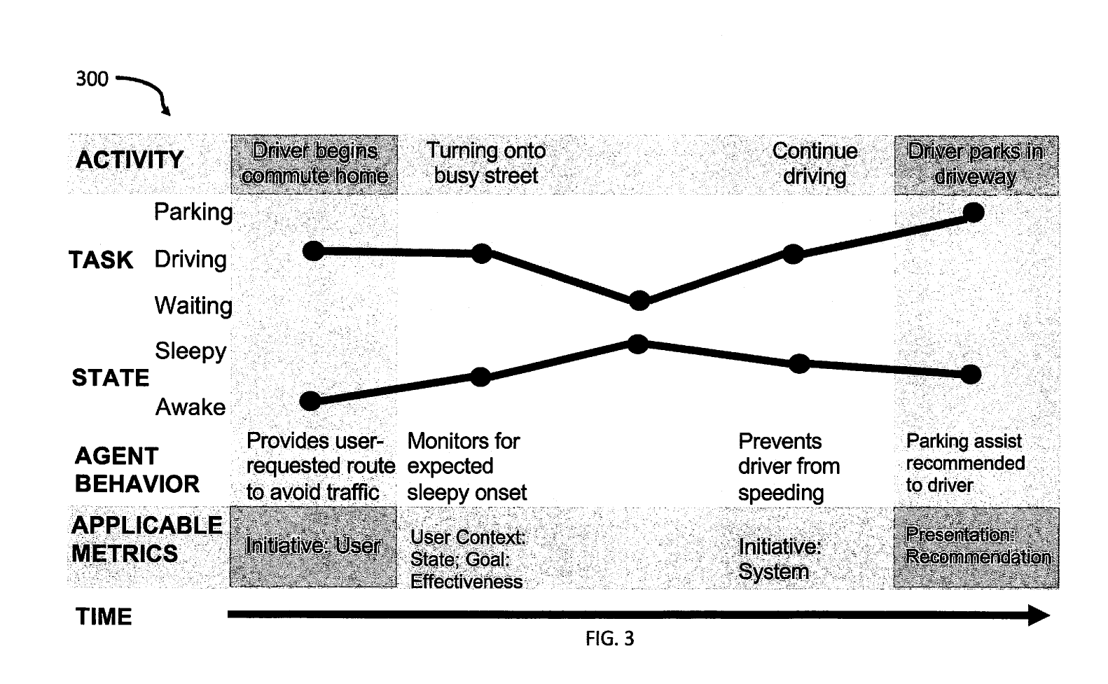

In one embodiment, a co-adaptive agent can adapt a graphical user interface for an application to suit the user's needs. However, other embodiments can be employed, such as for a semi-autonomous or fully-autonomous vehicle. Much like the graphical user interface, a car and the driver illustrated in FIG. 3 can be co-adapted for better performance. As the co-adaptive HCI learns about the user, either a car or a graphical user interface can be a mixed initiative system in a shared workspace, where the user can exert control by selecting functions, and the graphical user interface or vehicle can exert control by providing better functions/interface controls to the user. This increases efficiency for the user of either system.

In an embodiment of the present invention, the design of a user interface adapts based on the parameters that the co-adaptive HCI is adapting to. Instead of adapting to one parameter, or adapting information offered by the application, the layout can be adapted based on the calculated parameters. An Application Programming Interface (API) can be provided that receives information about an operating system or an application, and respond with adaptations that can be presented to the user in the GUI or operating system (OS). All user actions are identified as events, and input into a computational model. The model can then provide recommendations for the layout of the GUI in real time, in response to each user interaction, or in response to a set number of user interactions in order to minimize the number of user interface changes.

FIG. 3 is a diagram illustrating a user experience map of an exemplary co-adaptive system. Referring to FIG. 3, a specific embodiment of a co-adaptive system 110 comprising a user 120 and a car that has autonomous capabilities may be described by a user journey map 300. This example of a co-adaptive system 110 features a user commuting home in a semi-autonomous car. The user has traits of being an experienced driver who tends to speed and become sleepy during the commute, as captured in the car's model of the user's behavior-an example of a user model. The car and the human exhibit a mixed initiative system in a shared workspace. The human and agent can each exert control. They are co-located and working with the same goals. Overall system performance assessment centers around the goals of effectiveness and efficiency, as the agent 100 and user 120 both want to commute safely and quickly.

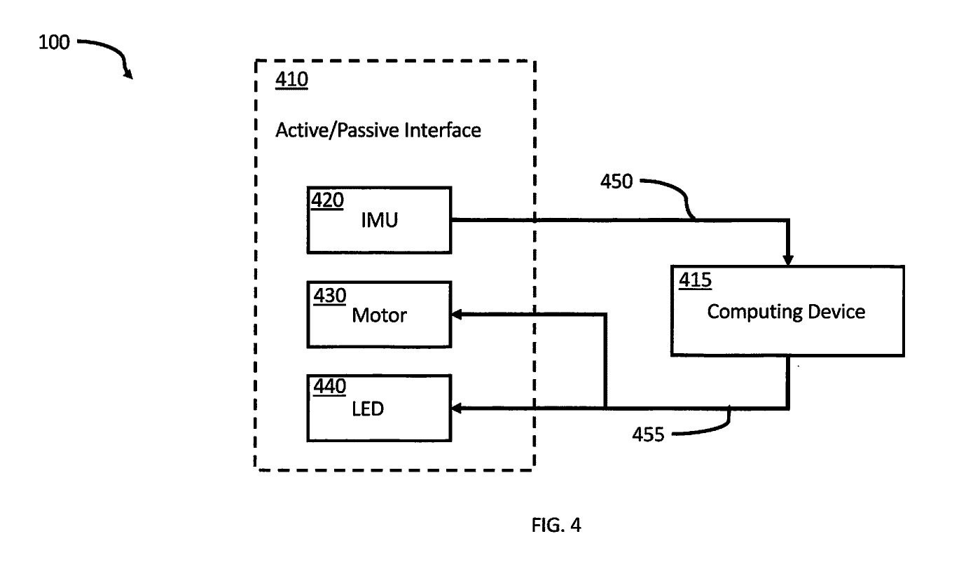

Referring to FIG. 4, a specific embodiment of a co-adaptive agent 100, may comprise an active/passive interface 410 and a computing device 415. The active/passive interface 410 is capable of both receiving input from a user 120 and returning feedback stimulus to the user 120. The user 120 may provide input by touching or moving the active/passive interface 410, speaking, gesturing with hands, head, eyes, or other body part, or by performing any other act that can be sensed by the active/passive interface 410. FIG. 4 illustrates an embodiment in which an inertial measurement unit (IMU) 420 receives input by measuring motion imparted by a user 120 to the active/passive interface 410. In embodiments, the active/passive interface 410 may comprise motors 430 and light emitting diodes 440 (LEDs), as illustrated in FIG. 4, to provide tactile and visual feedback to the user 120, but audio, thermal, olfactory, or any other actuator capable of being perceived by the user 120 may also, or instead, be used.

In embodiments, a sensor interface 450 communicates sensor signals from the active/passive interface 410 to the computing device 415, while an actuator interface 455 communicates signals controlling the motors 430, LEDs 440 and any other actuators in the opposite direction. The sensor and actuator interfaces 450 and 455 may comprise any combination of electrical, optical, wireless, or other communication channel.

In embodiments, the computing device 415 may be a mobile computing device, for example a smartphone, tablet, or personal digital assistant. The computing device 415 may be affixed to the active/passive interface 410 or separate from it.

In a specific example, the active/passive interface 410 may be implemented in a spherical machine toy manufactured by Sphero and known by that name. A Sphero incorporates an IMU 420, motors 430 and LEDs 440 that can form both an input and feedback device. As part of an exemplary co-adaptive system 100, a Sphero may be programmed to be an input device to control the position of a user 120 trying to navigate a virtual maze. The Sphero is further programmed to provide the user co-adaptive feedback in response to its inputs, in accordance with the principles outlined above. When the user's behavior becomes invalid, such as when the user 120 attempts to use the Sphero to guide a cursor to move through a wall of a digital maze, the Sphero provides feedback to inform the user 120 that the attempted movement is invalid. The Sphero's IMU 420 can be used to sense how the user 120 is moving it and the agent 100 can determine from that motion the velocity with which to move the user's location in the virtual maze. When the agent 100 detects that the user is attempting to move to an invalid location, the Sphero's actuators provide visual feedback by changing the color of its LEDs 440 and tactile feedback by moving the motor 430 in a direction opposite to the current motion, which the user 120 can feel as a shift in the Sphero's center of mass. Such feedback provides an alert that the user 120 is moving in the wrong direction and facilitates mutual adjustment of the agent 100 and the user 120.

Measurements of user behavior over time, for example the distribution of speeds at which the user 100 moves the Sphero, may be used to adapt the properties of the co-adaptive agent 100 of which it is a part. For example, a high incidence of very fast motion may cause the agent 100 to change the gain of an input transfer function that is part of its user model.

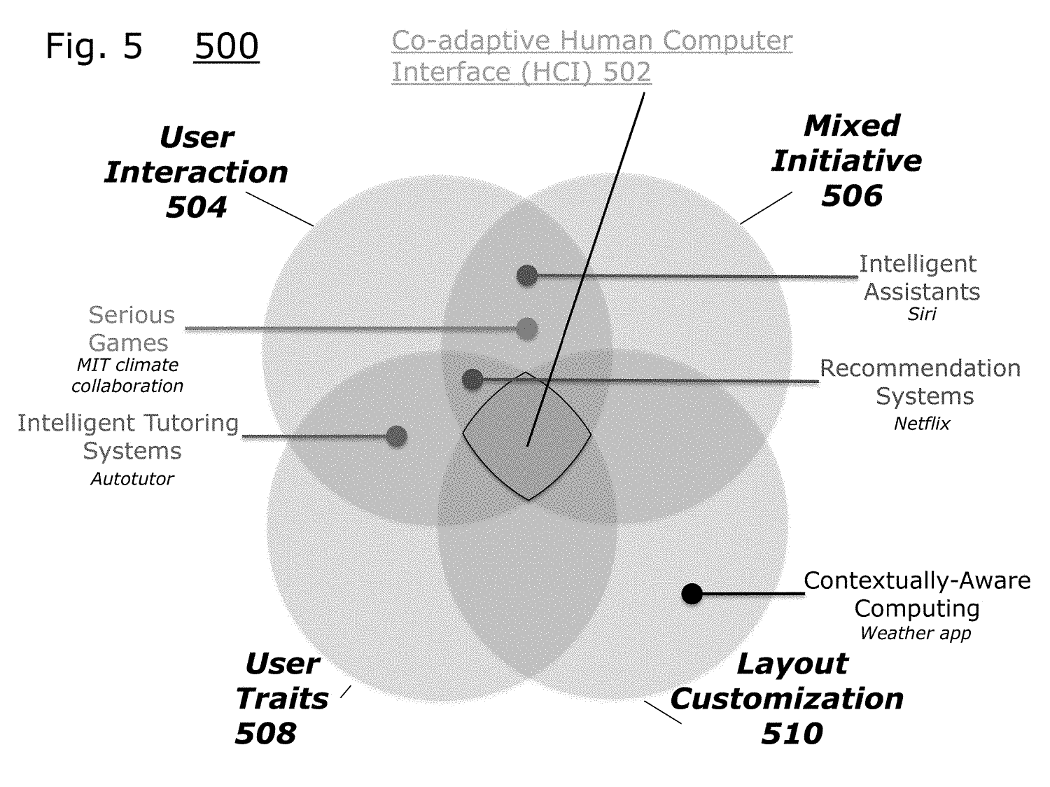

FIG. 5 is a diagram 500 illustrating example domains of technology used by a co-adaptive human computer interface (HCI) 502. A co-adaptive HCI can be used to enhance learning. A co-adaptive HCI employs one or more computational models correlate user traits and user interaction. Typically, co-adaptive HCI models do not model environment context, however. In an embodiment, a co-adaptive HCI system can adapt to user traits 508 and user interaction states 504, and employ mixed initiative systems 506, and employ layout customization 510. An ideal co-adaptive HCI 502 employs aspects of all user traits 508, user interaction states 504, and mixed initiative systems 506 to provide a customized layout. Current systems, such as a recommendation system of Netflix, for example, may combine user interaction 504, user traits 508, and mixed initiative systems 506. However, no system currently also models environment context to customize the layout 510 of a user interface based on user traits 508, user interaction 504, and mixed imitative systems 506. While some intelligent tutoring systems provide content well-suited to user traits, this type of adaption is rare in current systems. Further, no current systems tailor interface layout based on user traits. Co-adaptive systems are a type of mixed-initiative autonomy which tailors interface layout and behavior for individuals based on all or some of a subset of a user traits and user interaction.

One of the advantages of such a co-adaptive HCI 502 is that the co-adaptive HCI 502 improves user performance of the underlying system employing the HCI 502. The user performance is improved, firstly, by the adaptations occurring to the user interface automatically, instead of by the user manually. The user performance is also improved, secondly, by the co-adaptive HCI 502 presenting a more useful user interface to the user. This, for example, provides easier access to commands the user is likely to use in the future. These advantages decrease the amount of time the user spends customizing the user interface, and also the amount of time the user spends looking for a command that may be hidden within menus or dialog boxes. Therefore, the user can save time and decision making and increase his or her performance and efficiency by using the co-adaptive HCI 502, thereby reducing time spent customizing and navigating the interface, and instead using the interface for its intended purpose.

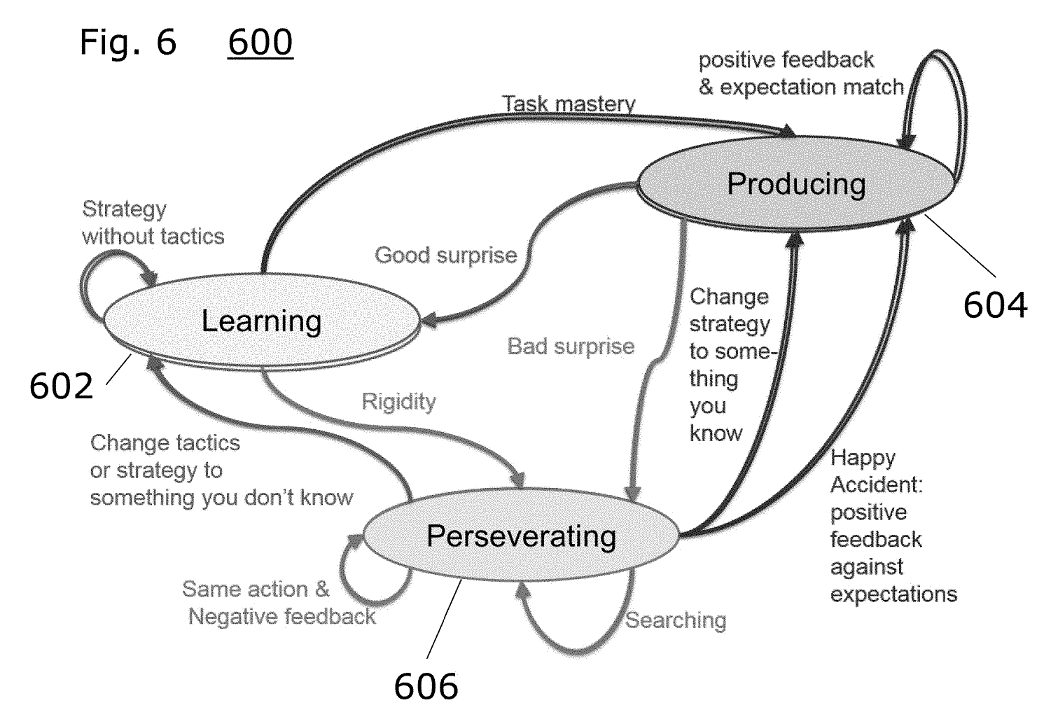

FIG. 6 is a state diagram 600 illustrating example states that a user may be in while using an interface including a co-adaptive human computer interface (HCI). Typically, as users explore a new system with a graphical user interface, they cycle through 3 major states: (1) learning 602 about a specific feature or method of achieving a goal; (2) producing 604 content directly related to the goal and making progress; and (3) perseverating 606, or running into dead ends and struggling to make progress. A co-adaptive HCI aims to have the user be in the producing 604 state as much as possible, while avoiding the perseverating state 606.

A user usually begins a task at the learning state 602. Without tactics, the user can guess functionality, but returns to the learning state 602 until they achieve results with task mastery and advance to the producing state 604. The user can then receive positive feedback and an expectation match and continue being in the producing state 604. However, surprises in the user interface can lead the user to return to the learning state 602 to learn new features, or perseverating state 606, where the user struggles to make progress. A change in the user's strategy can return the user to the learning state 602 or producing state 604, or an accident may allow the user to return to the producing state 604.

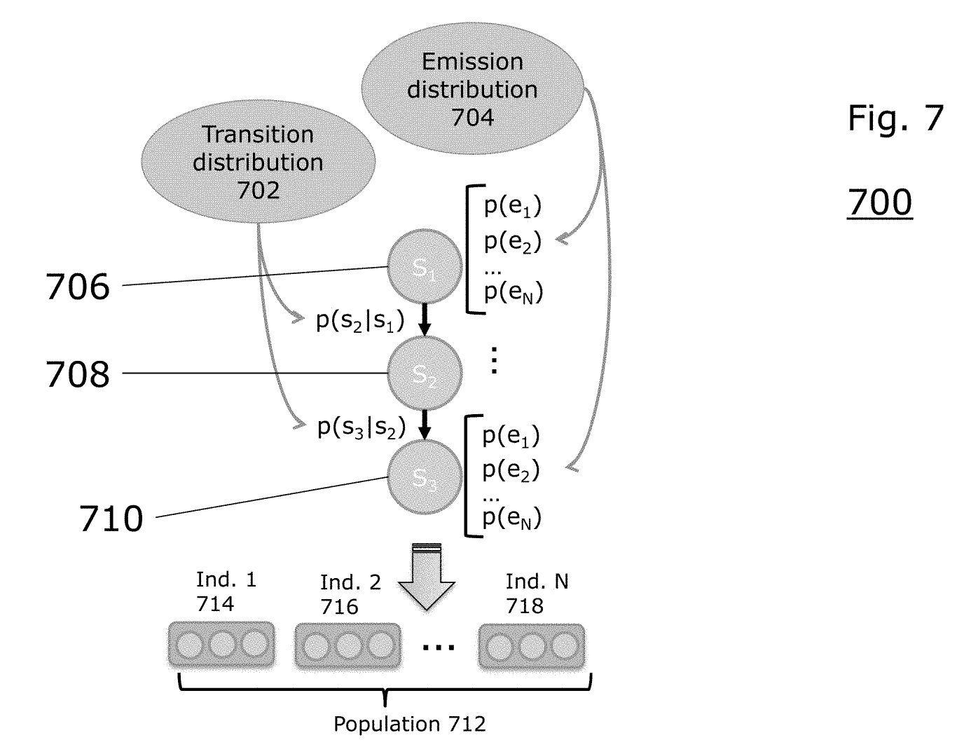

FIG. 7 is a diagram 700 illustrating an example of distributions for testing a co-adaptive HCI. In an embodiment, the system builds a generative model of users. The generative model is a probabilistic model that outputs a high-level use of a user interface (UI) control (e.g. button presses). The generative model provides a hypothesis for how users are expected to behave. Then, the machine learning algorithms can be trained on proxy data. The generative model is a Hidden Markov Model that state and 702 emission 704 probabilities are drawn from a distribution, which models the population of users 712.

The HMM population is created by, first, finding alpha values (selected from a Beta distribution) to populate transition matrix and emission probabilities. Then, the alpha values are used as parameters to a Dirchilet distribution, which gives probability of N categories that sum to 1.0, and therefore become probabilities. Then, it performs optimization on alpha values to match experimental data. Then, it creates a population of HMMs with alpha values that give a best match.

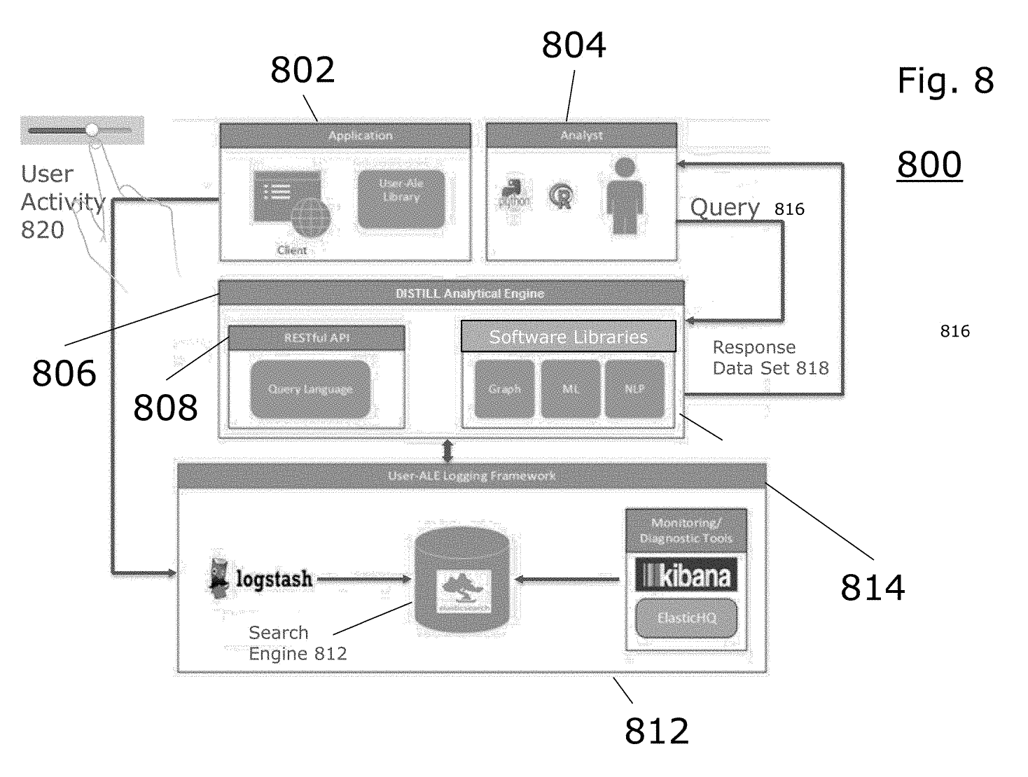

FIG. 8 is a block diagram 800 illustrating an example embodiment of the present invention. User activity 820 received at an application 802 is logged at a logging framework 812. The logging framework can be implemented by a tool such as logstash coupled with a search engine 812 and monitoring diagnostic tools. Each user activity 820 is uniquely identified. The logging framework 812 further is capable of clustering, filtering, and responding to queries via an analytical engine 808. The user activities 820 can be clustered by similarity metrics, such as temporal, spatial, and functional or goal based. These clusters can then be used to modify the user interface of the application, to promote user interface controls via one or more of the temporal, spatial, and functional clusters. The modifications applied to the interface are a function of the user context, UC, and a weighting scheme applied to the clusters of behaviors. Weights are determined based on an analysis of the software environment (for example: nature of engagement with the interface, # of steps to achieve goals, time required) and user context, UC. The more significant a cluster of user behavior, where significance defined in terms of quantity of the user behavior, the more influence a cluster has over what potential modifications are to be applied to the interface. A formula for describing this complicated relationship: Modifications=UC*((weight*behavior cluster A)+(weight*behavior cluster B) . . . ). The formula for expressing the weighting scheme can be more nuanced, dependent on the major interactions involved with the software environment. A logistics dashboard for example, can focus the weightings on criteria such as timing, job role of user and goals (each will have particular tasks to accomplish during a shift), pre-computed number of steps to achieve each task, and mouse clicks and movement behavior. These variables can be necessary to properly evaluate the importance of temporal, spatial, and functional clusters of behavior.

For example, consider the example of mouse movement behavior. A user can move a mouse independently and separately from selecting an actual command or series of commands These user interactions can be clustered accordingly. For example, the system can cluster the user activity of mouse movements that are not associated with a command selection. Such a cluster can indicate the user is confused or trying to find a command unsuccessfully. Another cluster can include user activity of mouse movements that are associated with a command selection, which indicates that the user did successfully find the command. This data can then be used to update the interface. Commands that are easily found can be more likely to remain, while commands that are harder to find, but frequently used, can then be promoted to a more prominent location to the user. In addition, the cluster of user mouse movements can determine, for each user's user profile, what locations in the user interface are more prominent for that particular user as well. Therefore, certain display locations being prominent (e.g., center, corners) may be different for different users, and can be modified as such.

In addition, a user trait (or goal) model can be provided based on a function of a user's mouse behavior. The user trait, or need for cognition (NFC), can be considered as part of the following relationship: NFC=f(mouse behavior). A more detailed version of this equation can be NFC=f(Σₜ₌₀^{t=g} w*Pₜ), where t is time, P is position, g is goal, and w is a weighting factor. The goal g refers to the time at which the user selects (e.g., clicks on) the goal. The weighting factor w is optional and can be set to 1 in certain embodiments.

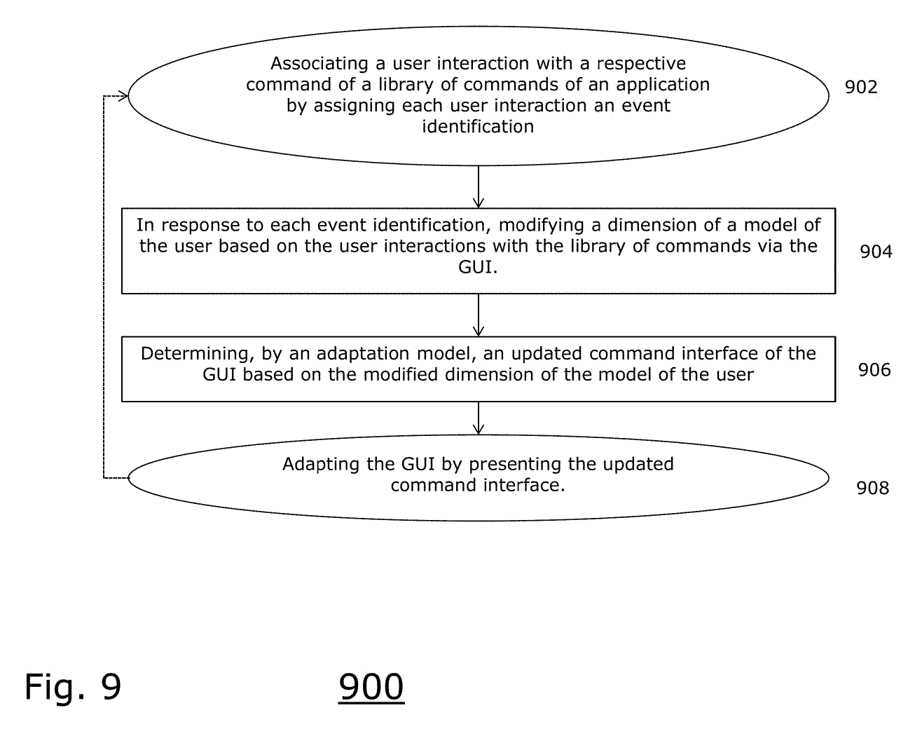

FIG. 9 is a flow diagram 900 illustrating an example embodiment of a method of the present invention. The method associates one or more user interactions with a respective command of a library of commands of an application run by a processor by assigning each user interaction an event identification (902). The user interactions are inputted to a graphical user interface (GUI) presented by the application to a user. The user interactions can be inputted to the GUI by an input device such as a keyboard, pointing device such as a mouse, voice input, or any other input. The method then, in response to at least one of the event identifications, modifies one or more dimensions of a model of the user based on the plurality of user interactions with the library of commands via the GUI (904). Then, the method determines, by using an adaptation model, an updated command interface of the GUI based on the modified dimension of the model of the user. Then, the method adapts the GUI of the application by presenting the updated command interface. With the above method, a user interface can be adapted present commands more likely to be of use to the user, simply based on the user's interactions with the GUI.

Optionally, after adapting the GUI (908), the method can repeat by associating a new user interaction with a respective command and assigning a next event identification (902), and continuing the process as described above.

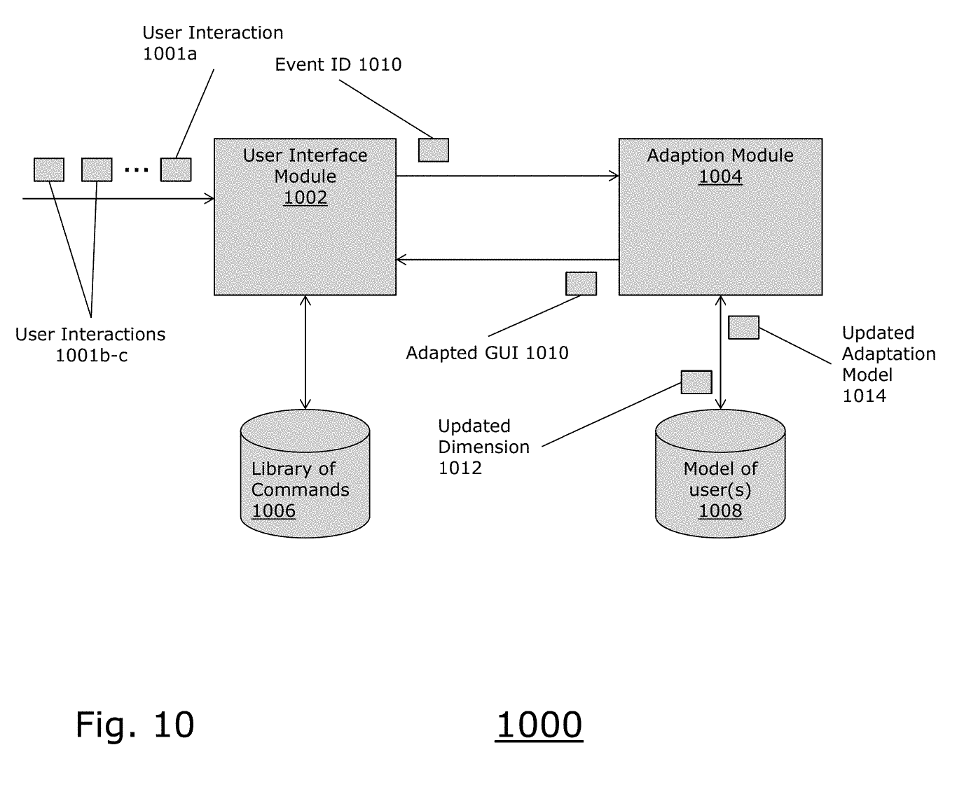

FIG. 10 is a block diagram 1000 illustrating an example embodiment of a system employing the present invention. A user interface module 1002, in response to user interaction 1001a, a user interface module 1002 associates command of the library of commands 1006, and generates an event ID 1010. The event ID 1010 is forwarded to an adaptation module 1004. The adaptation module processes the event ID 1010, user interaction 1001a, and the respective associated command from the library of commands 1006, and updates, if necessary, a dimension 1012 of a user model 1008. The dimension of the user can refer to aspects such as user context, environmental context, or personalization. The adaptation module 1004 then provides an updated adaptation model 1014, and can produce an adapted GUI 1010 based on the updated adaptation model 1014, which is sent to the user interface module 1002.

Then, as new user interactions 1001b-c are received at the user interface module 1002, similar actions can be taken to modify the user model and adapt the GUI further. In this away, each user interaction 1001a-c contributes to adapting the GUI directly for the user without any manual customizations by the user.

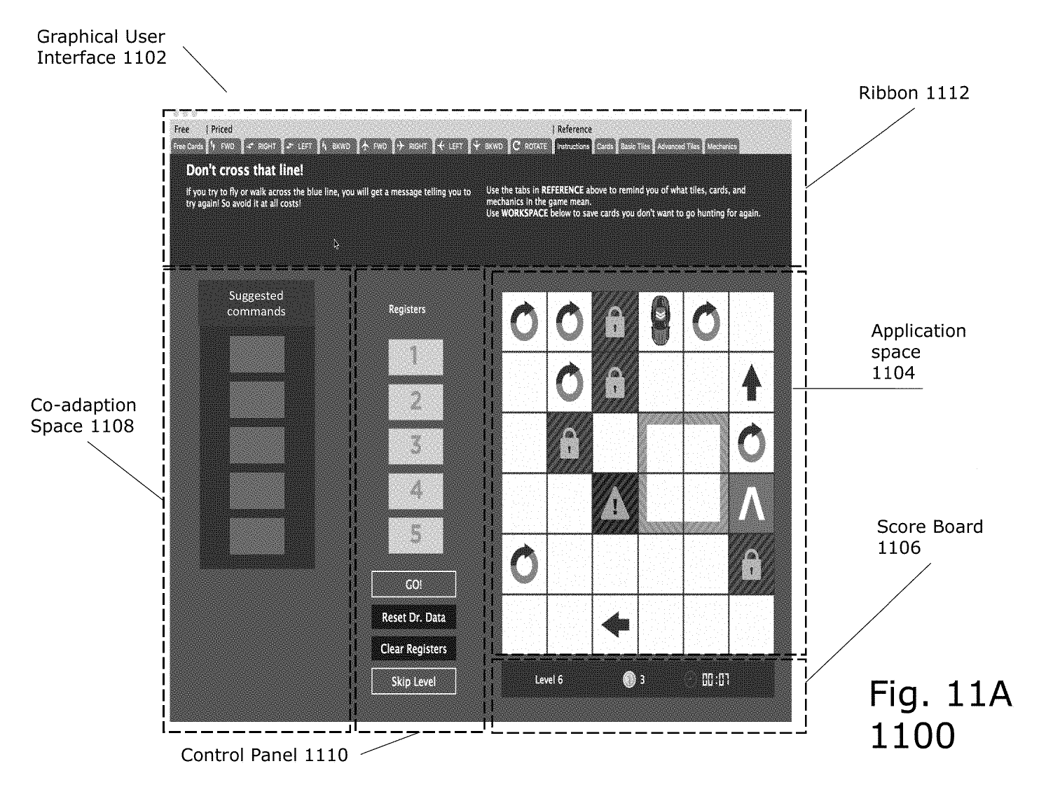

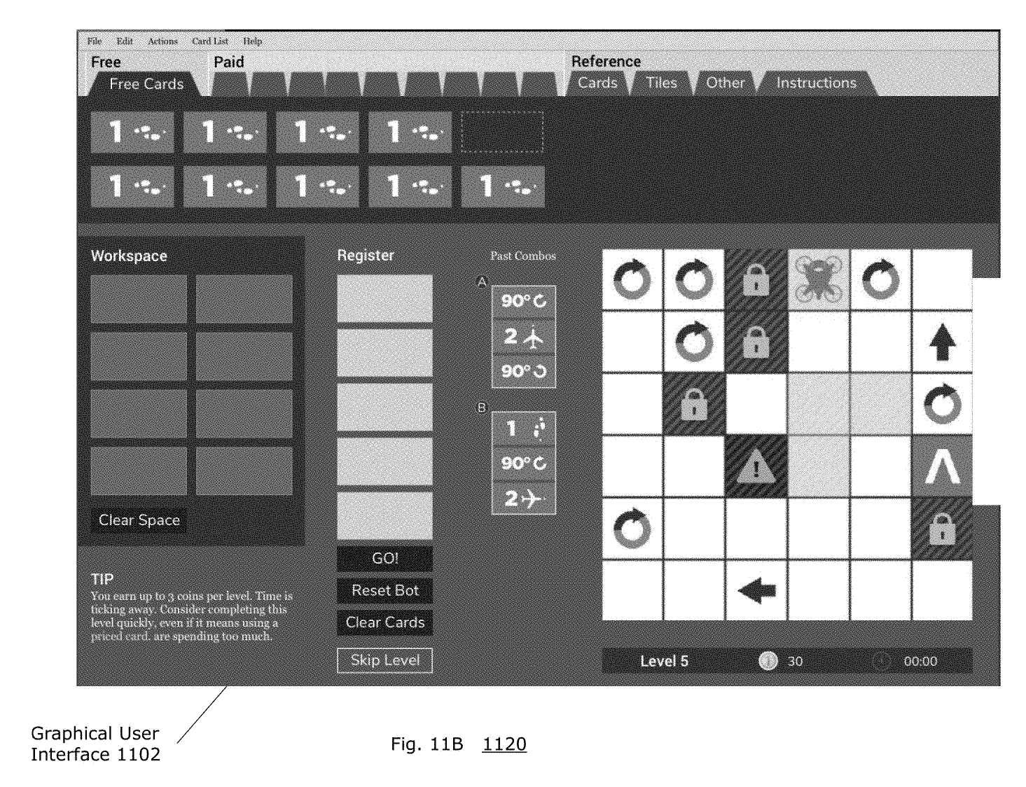

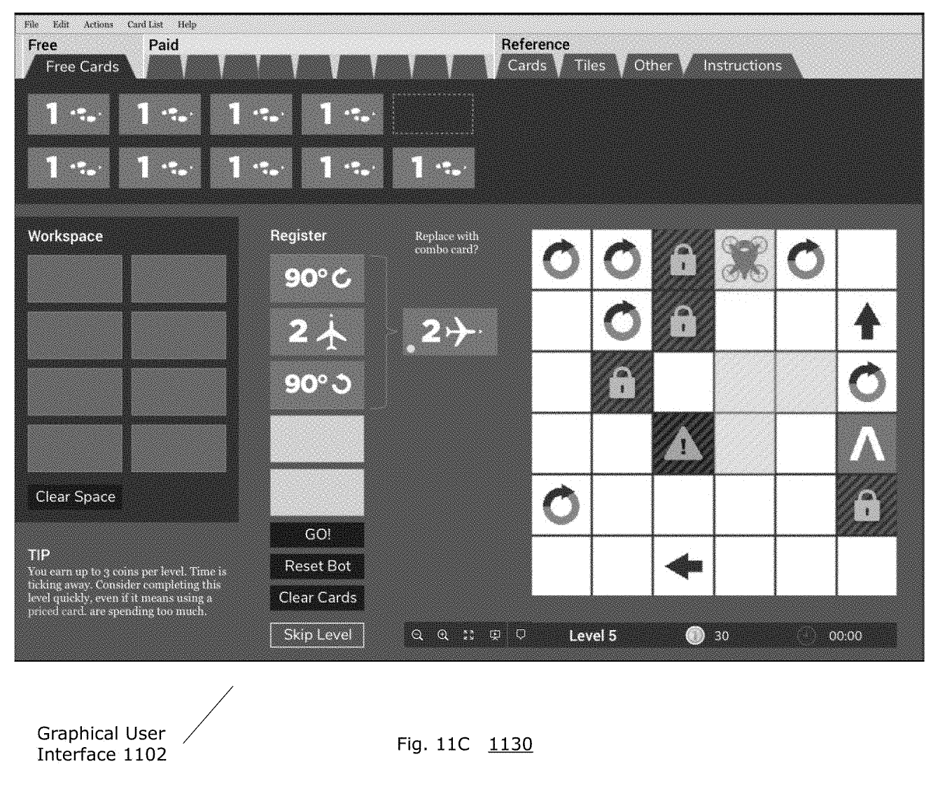

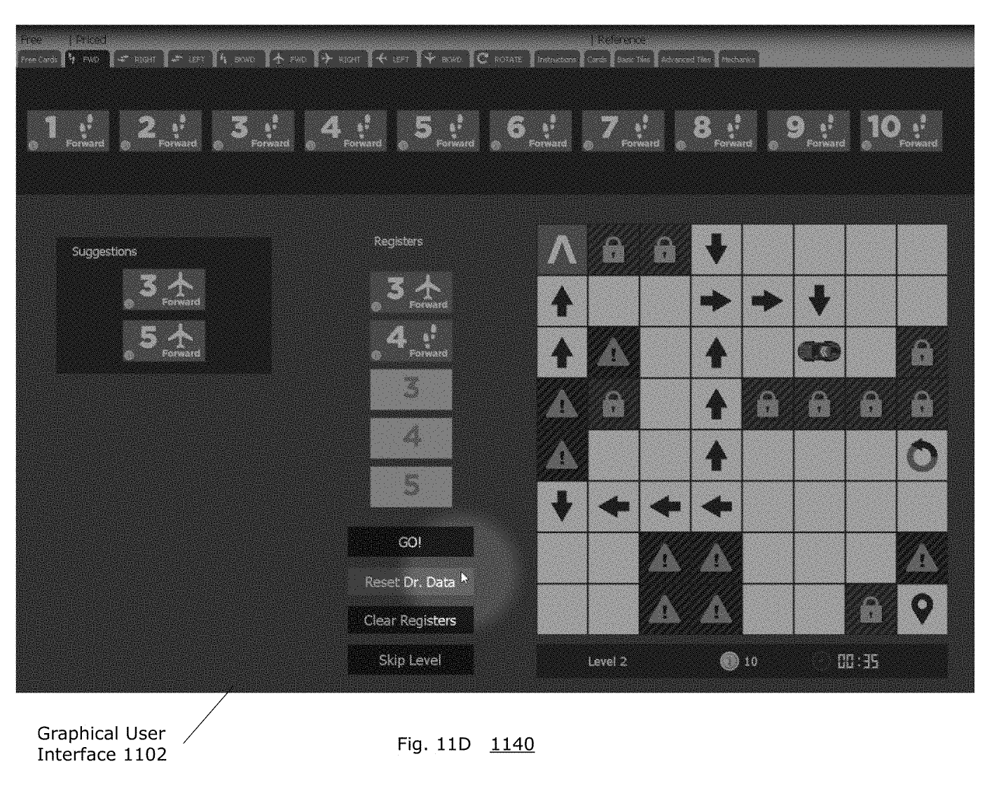

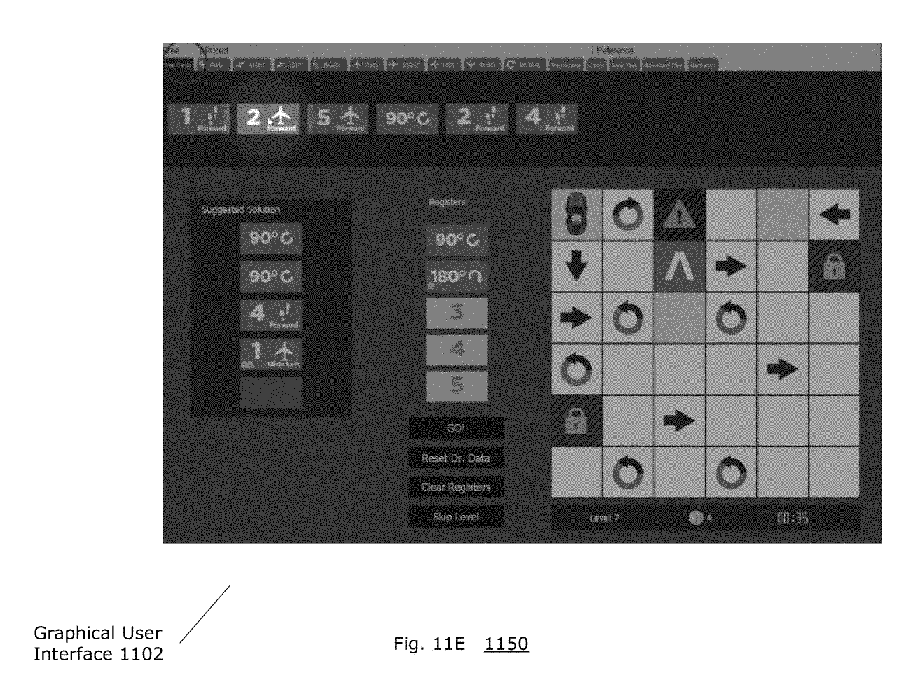

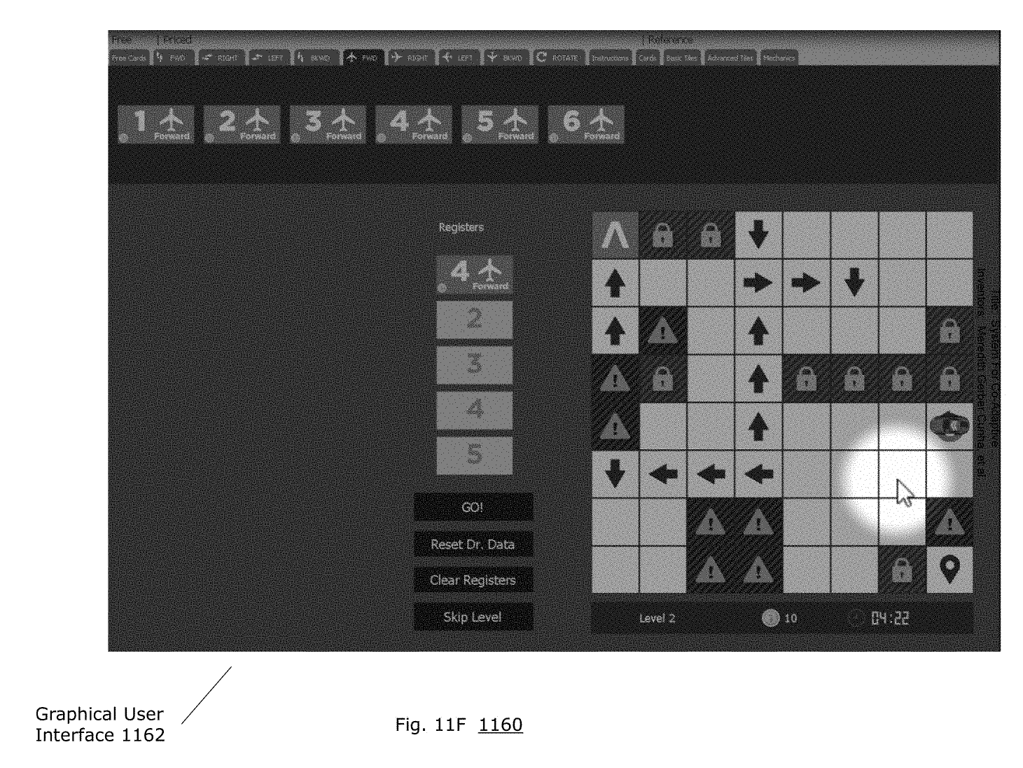

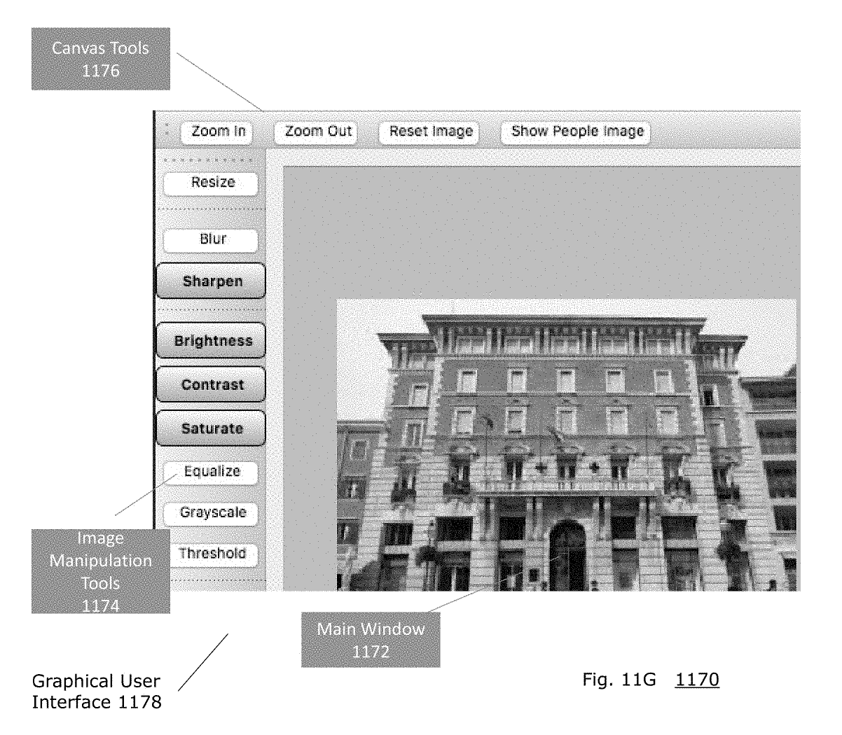

FIG. 11A is a diagram 1100 illustrating an example embodiment of a graphical user interface (GUI) 1102 employed by the present invention. The GUI 1102 includes an application space 1104, score board 1106, co-adaption space 1108, control panel 1110, and ribbon 1112. The application space 1104 is an area of the graphical user interface 1102 that shows the application's main features. In this example, the application space 1104 is a game having the objective of returning the car to a home square and avoiding various obstacles and special movement tiles. The control panel 1110 includes registers and buttons. A ribbon 1112 includes free and priced cards which are controls to move the car (e.g., ground based forward, right, left, backwards, flying forward, right left, and backwards, and rotation), as well as reference tabs (e.g., reference on instructions, cards, basic tiles, advanced tiles, and mechanics). The ribbon 1112 can co-adapt in accordance to the features above to display helpful tips or hints to the user to complete the level he or she is playing. The ribbon 1112, in this example, shows a co-adaptation having a tip of “Don't cross that line” advising the user not to cross the blue line. Other co-adaptations include tips explaining how to use the Reference tab and Register Workspace. These co-adaptions are based on the user preferences and traits, as described in accordance with the concepts in this application. The registers hold cards in order to create solutions for the map of the application space 1104. The buttons of the control panel 1110 allow the user to try their solution, reset the board or registers, or skip the level.

The cards are analogous to features from any other application. The cards are illustrative in the game shown here to show features of co-adaptation. However, a person of ordinary skill in the art can recognize that each card of the illustrated game could be a feature of another application, such as a word processor, spreadsheet application, web browser, or 3D modeling application (e.g., computer-aided design (CAD), computer aided engineering (CAE), product lifecycle management (PLM) program). For example, a feature of a CAD program could be to place a particular shape into a scene, to rotate an object, to move an object, etc. Meanwhile, the reference section of the GUI 1102 is analogous to a help or training section of another application.

In addition, the score board 1106 can display the current level, number of coins accumulated by the user, and time spent on this level. The score board 1106 can co-adapt with the user to show different types of information, and can update the information in real time as the user uses the application. Last, the co-adaption space 1108 provides suggested commands based on the user's past interactions, and information from the application space 1104 (e.g., the level being played, position of the car, etc.).

FIG. 11B is a diagram 1120 illustrating an example embodiment of the graphical user interface 1102 employed by of the present invention. The GUI 1102 here displays a co-adaptation showing a user's history of moves having two past combos, A and B, both being that the user previously attempted. Further, the GUI 1102 provides an adaptation of another tip in this example—that up to three coins can be earned per level, and advocates for using a priced card. In addition, the “paid” ribbon is highlighted, indicating that the user should select it. The tips illustrated in FIG. 11B are co-adaptively provided based on user performance and/or user traits. In another application, tips can be shown describing or suggesting features of that application.

FIG. 11C is a diagram 1130 illustrating an example embodiment of the graphical user interface 1102 employed by the present invention. After the user loaded a 90 degree clockwise turn, fly two squares, and 90 degree counter clockwise turn into the register, the system responds by co-adaptively suggesting a replacement combination card. The co-adaption of the replacement combination card flies the drone two squares to the right, eliminating the need for the rotations. The co-adaption of the replacement combination card is helpful to the user because the number of registers is limited. Therefore, this co-adaptation enables the user to use tools more efficiently to solve the puzzle. In the context of other applications, a person of ordinary skill in the art can recognize that users with limited time can benefit from actions being combined to save the user time. Those other applications can therefore show the user better features to use that may combine multiple features together, or otherwise save the user time.

FIG. 11D is a diagram 1140 illustrating an example embodiment of the graphical user interface 1102 employed by the present invention. The GUI 1102 then displays determined suggestions to the user automatically. These suggested suggestions are co-adaptively based on the user's history, suggesting cards the user prefers based on his or her history. As one illustrative example, the cards can be suggested because the user selects these cards based on similar board scenarios. The suggestions further are for individual cards. The user can accept or ignore these individual car suggestions. However, the “five flying forward” suggestion would put the vehicle on the up arrow, causing it to reach the finish square in the top corner. Other applications can suggest similar individual features to the user based on the user's history and the task the user is working on.

FIG. 11E is a diagram 1150 illustrating an example embodiment of the graphical user interface 1102 employed by the present invention. The graphical user interface 1102 displays a suggested solution of two 90 degree turns, 4 forward walks, and one slide left. The suggested solution is co-adaptively based on the user's history, suggesting a combination of cards the based on the user's preferences or traits, or how others solved the particular level. In contrast with the example illustrated in FIG. 11D, the example in FIG. 11E suggests a combination of cards to be used together in order, where the solution in FIG. 11D suggested individual cards. Both types of suggestions can be helpful to the users. The user can accept or reject this solution when creating his or her own in the registers.

FIG. 11F is a diagram 1160 illustrating an example embodiment of a graphical user interface 1162 employed by the present invention. The register includes a four step flying forward command. The graphical user interface 1162 has no co-adaptive features, and is shown to illustrate the example game having no co-adaption built in.

FIG. 11G is a diagram 1170 illustrating an example embodiment of a graphical user interface (GUI) 1178 employed of the present invention. In this embodiment, the GUI 1178 is of an image manipulation program having a main window 1172, image manipulation tools 1174, and canvas tools 1176. Here, the graphical user interface 1178 has highlighted various image manipulation tools based on a determination of the user's next actions. The highlights are the co-adaptation determined by the adaptation model to adjust the GUI 1178. In particular, Sharpen, Brightness, Contrast, and Saturate are highlighted. However, a person of ordinary skill in the art can determine that other tools or commands could be highlighted for the user.

There are many types of adaptations/co-adaptions that embodiments of the present method and system can employ. For example, history tracking provides a history of past attempts at a level/task to learn from them. Card suggestions can provide suggestions of cards based on previous use, or suggestions of new cards to try. The system can further highlight a path to show a path where the user should guide a vehicle, or even a path where the user should guide the mouse to reach a button. The system can further change right click menus by adding shortcuts or suggestions in the right click menu, such as a pie menu. The system can further change animation speed based on the user's traits or behaviors. This can allow an expert user to save time by increasing or removing the animation speed, but also can provide slower animations for a novice user, who can learn from the animations clarity. The system can further create dynamic grouping, which groups cards or features based on base actions. The system can further provide progressive tips, which begin at a low level of invasiveness and increase the invasiveness if the user is not performing as well.

FIG. 12 is a diagram 1200 illustrating an example embodiment a CO-ADAPT module interfacing with a partner application. The CO-ADAPT module 1202 is a co-adaption package and toolbox. CO-ADAPT recommends performance enhancing adaptations based on users' traits and tasks. Higher scores on these trait scales indicate user experience gains from a corresponding adaptation.

For example, the user trait model 1206 of extroversion correlates with an adaptation engine score of dynamic content. In other words, a higher extroversion score for a user indicates that the user would like more dynamic content in its application or user interface. Likewise, a higher user trait model 1206 of trust indicates that the user needs more directive feedback, and a user trait model 1206 of higher need for cognition score means that the user needs more information presented to him or her.

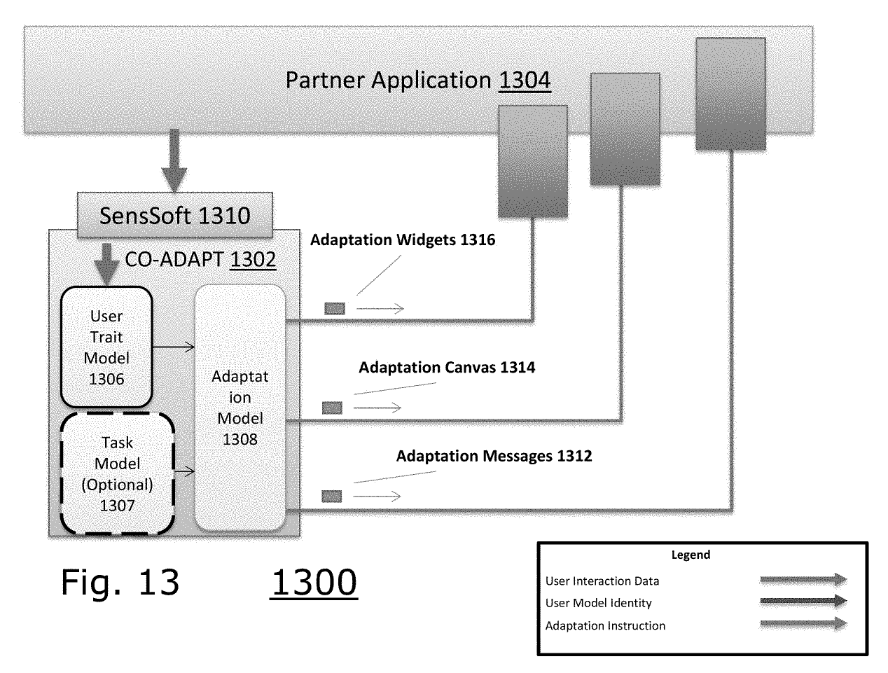

The adaptation engine 1208 translates these scores, based on the user trait models 1206, into adaptation instructions, which, in some embodiments, can be transferred to a partner application. Using a plugin or other application programming interface (API), the adaptation instructions can be used by the partner application to adapt its interface. While the partner application needs to have instructions on how to properly receive and implement the adaptation instructions, once received, the messages provide instructions on how to adapt the GUI. Therefore, while embodiments of the present invention can built into new applications and GUIs directly, it can also be used for existing applications as a plugin. FIG. 13 provides further details on different methods of providing adaptation instructions.

FIG. 13 is a block diagram 1300 illustrating an example embodiment of interfacing the CO-ADAPT module 1302 with a partner application 1304. A SensSoft module 1310 receives user interaction from a partner application 1304, and translates, if necessary, to the CO-ADAPT module 1302. Examples of translation can be giving each user interaction an event ID or categorization. In response, the CO-ADAPT module 1302 modifies its user trait module 1306. The CO-ADAPT module 1302 then modifies its adaption model 1308 in response. Then, the adaption module returns adaption instructions in one of three ways.

In an embodiment, the CO-ADAPT module 1302 further implements a task model 1307. The task model can be a model separate from the user trait model 1306, or incorporated into/within the user trait model 1306. For purposes of simplicity, FIG. 13 illustrates the example embodiment where the task model 1307 is separate from the user trait model 1306. However, a person of ordinary skill in the art could, from the disclosure of the block diagram 1300 of FIG. 13, implement an alternate configuration of the task model 1307 being within the user trait model 1306. The task model 1307 receives each user interaction/event ID from SensSoft 1310 as well, and models the task that the user, or group/team of users are attempting to accomplish. Once the task has been identified by the task model 1307, the adaptation model 1308 can use that information to adjust the user interface of the partner application 1304 to be better suited for that task. For example, features commonly used for particular tasks can be brought to the forefront of the user interface, or made more prominent by increasing the size of their buttons, or making their typeface larger or bolder. In addition, features irrelevant to the determined task can be removed from the user interface of the partner application 1304.

The first manner is that adaption messages can be sent to the partner application. The adaption messages are adaption instructions that are sent to the partner application (e.g., via a network or bus) that the partner application can then act on in a desired manner. For example, the adaption message can relay an aspect of the adaption model 1308 to a partner application 1304 that is programmed to react to such a message. This places much of the user interface modification load on the partner application, and little on the CO-ADAPT module 1302.

The second manner is that an adaption canvas is established in the partner application 1304. The adaption canvas, which is an area designated as adaptable within the partner application that will control objects placed within it. If established in the partner application 1304, the CO-ADAPT module 1302 can directly place objects within the application canvas, but not other parts of the application. Such a setup shares the modification load between the CO-ADAPT module 1302, which provides the modifications to the canvas, and the partner application, which is modified to include instructions to establish such a canvas.

The third manner are adaption widgets. Adaption widgets are objects that developers can create, and subsequently place in their US, that respond to adaption instructions. Adaptation widgets place the least amount of work on the partner application 1304 side. Adaption widgets can be placed into (e.g., floating, into a fixed position, etc.) the partner application 1304 for interaction with the user. The widget can be a control, button, dynamic content, etc. The message of the adaptation widget can include either executable code for the widget, or the name/location of a library containing the same, the location of the widget to be placed in the application, and other properties needed for the widget (e.g., any initial data to display, user data, etc.).

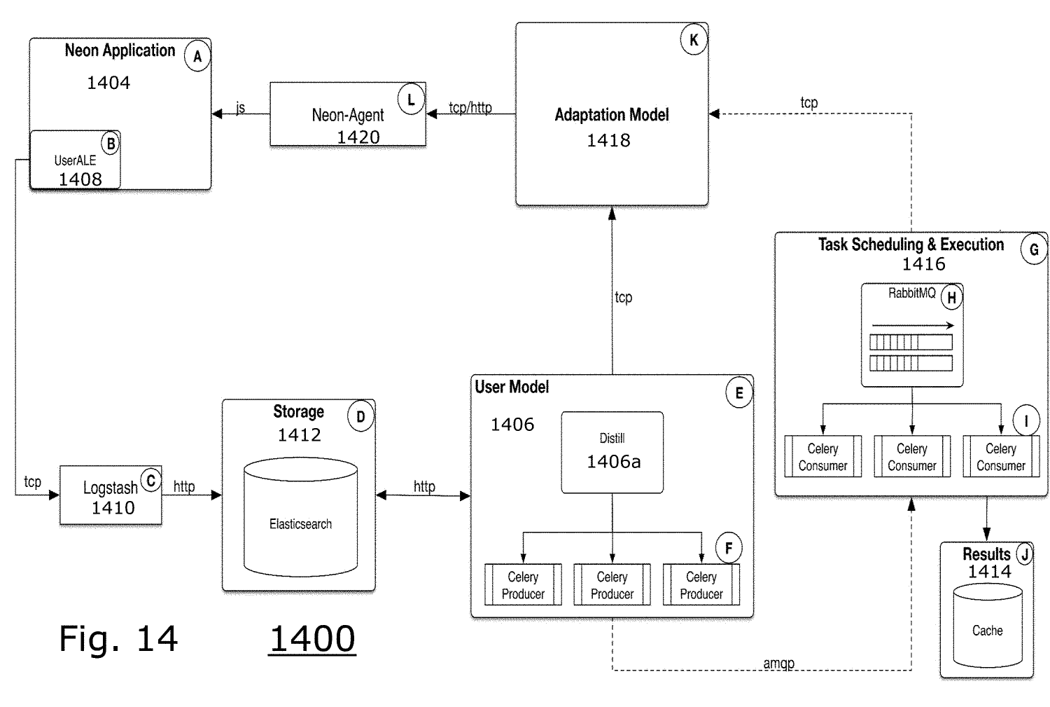

FIG. 14 is a block diagram 1400 illustrating an example embodiment of the present invention. An application 1404, such as a Co-Adapt Neon application instance, is instrumented with Apache UserALE 1408 or an equivalent event tracking module. All user events are captured and sent to a logging server 1410. The logging server, which can be implemented using Logstash, receives the UserALE events and bulk indexes its contents into a storage module 1412, which can be implemented using Elasticsearch. Elasticsearch indexes all user event tracking data for later exploration and analysis.

A user model 1406 generates user traits from the received user event tracking data. An instance of Apache Distill 1406a creates processing tasks that are queued up in RabbitMQ and processed at a later time. Apache Distill 1406a analyzes user activity logs, such as logs from a UserALE module, and can apply certain analytical operations to the logs. A person of ordinary skill in the art can understand other modules can be employed to analyze the user activity logs and apply analytical operations, however. Apache Distill 1406a can create certain worker processes that create tasks for later analyzation. To make Apache Distill 1406a as responsive as possible, all processing is pushed to an asynchronous queue where workers (e.g., threads) pop an element from the queue and execute its operation.

RabbitMQ is an example of a message broker in a task scheduling and execution module 1416 that routes tasks produced from Apache Distill to various queues, and then directs tasks to a consumer threat, which pops a message off its queue and executes its operation.

The tasks (input, output, state) can be called celery tasks and be handled by celery producers and workers, and stored in a results cache 1414 such as Redis or Elasticsearch. The results from the User Model 1406 are sent to the Adaptation Model 1418. FIG. 12 illustrates the translation of user traits of the user model 1406 being translated to adaptation engine factors. Referring to FIG. 14, given the trait information, the adaptation can recommend a change to the interface to a receiving agent 1420 (e.g., Neon-agent). The Neon-Agent 1420 listener executes a change based on a recommendation from the Adaptation model 1418. There can be multiple Neon-Agents 1418 that perform different operations based on confidence levels of the user model 1406a and adaptation model 1418.

A person of ordinary skill in the art can further recognize from FIG. 14 that this process is iterative. As a user interacts with the application 1404 more, more recommendations can be received. The user can continue using the application 1404 as the recommendations continue to modify the application's user interface.

FIG. 15 is a table 1500 illustrating an example embodiment of weights used to determine user context. As described above in relation to FIG. 2, user context (UC) is a function of a weighted sum of trait, state, and task: UC=f(X*trait+Y*state+Z*task). The user model is a function of user context (UC) which is moderated by environmental context (EC) and personalization (P): UM=f(UC, EC, P). In relation to FIG. 15, relative weights of X, Y, and Z are shown for various scenarios. For personalization spectrum location 1, which is a solely population-based spectrum, X is very low, Y is very low, and Z is high. For personalization spectrum location 2, which is a population trait-group based personalization, X is moderate, Y is very low, and Z is moderate. For personalization spectrum location 3, which is a trait group based personalization, the weights X, Y, and are moderate, except for EC, which is very low. For personalization spectrum location 4, which is an individual-based personalization, all weights are moderate, including EC.

It would be appreciated by those skilled in the art that various changes and modifications can be made to the illustrated embodiments without departing from the spirit of the present invention. All such modifications and changes are intended to be covered by the appended claim.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

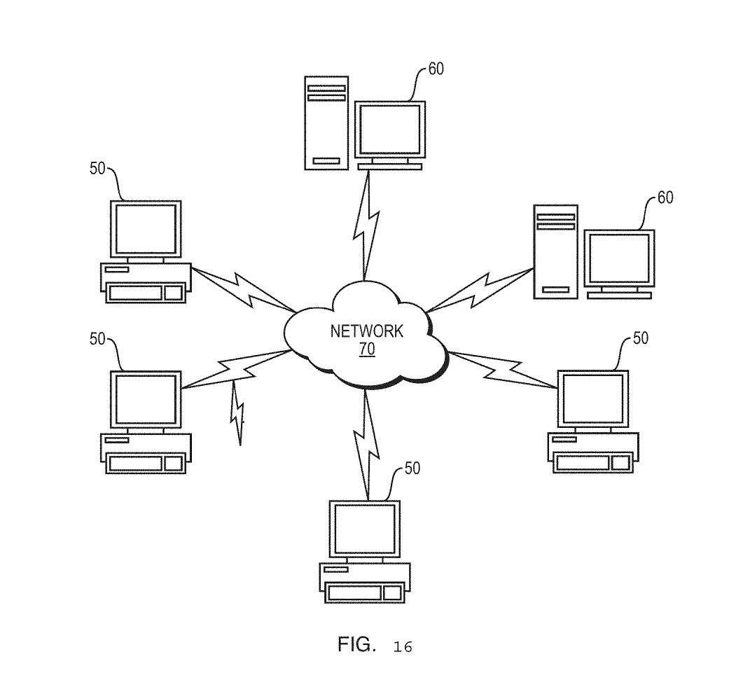

FIG. 16 illustrates a computer network or similar digital processing environment in which embodiments of the present invention may be implemented.

Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

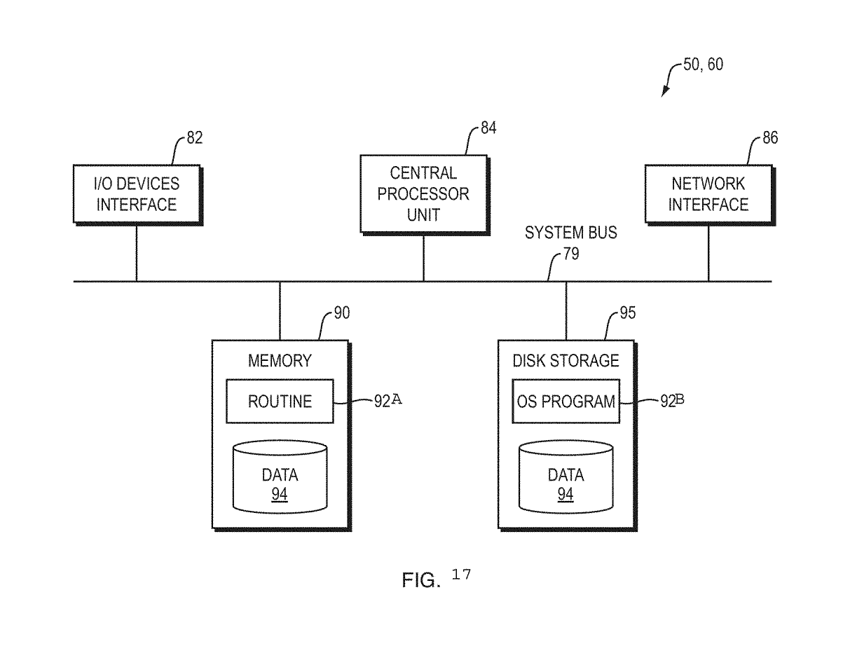

FIG. 17 is a diagram of an example internal structure of a computer (e.g., client processor/device 50 or server computers 60) in the computer system of FIG. 16. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 5). Memory 90 provides volatile storage for computer software instructions 92 and data 94 used to implement an embodiment of the present invention (e.g., CO-ADAPT module, SensSoft, Partner Application, Adaption Widget, Adaption Canvas, Adaption Messages, Adaption Model, User Model, Tash Scheduling and Execution Module, Storage Module, and Neon Application Module code detailed above). Disk storage 95 provides non-volatile storage for computer software instructions 92 and data 94 used to implement an embodiment of the present invention. A central processor unit 84 is also attached to the system bus 79 and provides for the execution of computer instructions.

In one embodiment, the processor routines 92 and data 94 are a computer program product (generally referenced 92), including a non-transitory computer-readable medium (e.g., a removable storage medium such as one or more DVD-ROM's, CD-ROM's, diskettes, tapes, etc.) that provides at least a portion of the software instructions for the invention system. The computer program product 92 can be installed by any suitable software installation procedure, as is well known in the art. In another embodiment, at least a portion of the software instructions may also be downloaded over a cable communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals may be employed to provide at least a portion of the software instructions for the present invention routines/program 92.

Insofar as the description above and the accompanying drawings disclose any additional subject matter that is not within the scope of the single claim below, the inventions are not dedicated to the public and the right to file one or more applications to claim such additional inventions is reserved.

What is claimed is:

1. A method comprising:
associating a plurality of user interactions with a respective command of a library of commands of an application run by a processor, the plurality of user interaction being inputted to the application and displayed by a graphical user interface (GUI) presented to a user, by assigning each user interaction an event identification;
in response to one of the event identifications, modifying at least one dimension of a model of the user based on the plurality of user interactions with the library of commands via the GUI;
determining, by an adaptation model, an updated command interface of the GUI based on the modified dimension of the model of the user; and
adapting the GUI by presenting the updated command interface.

2. The method of claim 1, wherein modifying the model of the user further includes clustering the user interactions into the at least one dimension.

3. The method of claim 1, wherein modifying the at least one dimension of the model of the user further includes determining how frequent one of the at least one user interactions occurs, and modifying a frequently used commands dimension of the model, and wherein adapting the GUI of the application further includes presenting command interfaces of the frequently used commands dimension.

4. The method of claim 1, wherein modifying the at least one dimension of the model of the user further includes determining a recency of the at least one user interaction, and modifying a recently used commands dimension of the model, and wherein adapting the GUI of the application further includes presenting command interfaces of the recently used commands dimension.

5. The method of claim 1, further comprising:
in response to one of the event identifications, modifying a task model based on the plurality of user interactions indicating a task or goal being performed by the user; and
determining, by the adaptation model, the updated command interface of the GUI based on the modified task model.

6. The method of claim 5, wherein modifying the task model further includes associating a sequence of the plurality of user interactions with the task or goal.

7. The method of claim 1, further comprising:
in response to one of the event identifications, modifying a task model based on the plurality of user interactions indicating a task or goal being performed by the user; and
determining, by the adaptation model, the updated command interface of the GUI based on the modified task model.

8. The method of claim 1, further comprising:
monitoring a plurality of subsequent user interactions with the presented command interfaces in the adapted GUI;
modifying the adaptation model used to adapt the GUI based on at least one of an efficiency score, changes to a modeled goal, changes to frequently used commands, changes to recently used commands, pattern of use, and changes to task model and the user model, wherein the efficiency score is based on use of the presented command interfaces in the adapted GUI; and
basing future adaptations of the GUI on the modified adaptation model.

9. The method of claim 1, wherein modifying the adaptation model is further based on an efficiency score, the efficiency score based on use of presented command interfaces in the GUI.

10. The method of claim 1, further comprising:
based on the adaptation model, providing a message to the application enabling at least one of an adaptation widget, adaptation canvas, or adaptation message, wherein the message of the adaptation widget enables the application to present the updated command interface by adding or removing a control of the application, the adaptation canvas provides a designated area within the application to present the updated command interface, and the adaptation message provides instructions for the application to present the updated command interface.

11. The method of claim 1, wherein determining the updated command interface is further based on a user trait of the model of the user, including user traits indicating need for dynamic content, directive feedback, and an amount of information presented in the GUI.

12. A system comprising:
a processor; and
a memory with computer code instructions stored therein, the memory operatively coupled to said processor such that the computer code instructions configure the processor to implement:
a user interface module configured to associate a plurality of user interactions with a respective command of a library of commands of an application run by a processor, the plurality of user interactions being inputted to the application and displayed by a graphical user interface (GUI) presented to a user by assigning each user interaction an event identification;
an adaptation module configured to:
in response to one of the event identifications, modify at least one dimension of a model of the user based on the plurality of user interactions with the library of commands via the GUI;
determining an updated command interface of the GUI based on the modified dimension of the model of the user; and
adapt the GUI based on the categorization by presenting the updated command interface.

13. The system of claim 12, wherein modifying the model of the user further includes clustering the user interactions into the at least one dimension.

14. The system of claim 12, wherein modifying the at least one dimension of the model of the user further includes determining how frequent one of the at least one user interactions occurs, and modifying a frequently used commands dimension of the model, and wherein adapting the GUI of the application further includes presenting command interfaces of the frequently used commands dimension.

15. The system of claim 12, wherein modifying the at least one dimension of the model of the user further includes determining a recency of the at least one user interaction, and modifying a recently used commands dimension of the model, and wherein adapting the GUI of the application further includes presenting command interfaces of the recently used commands dimension.

16. The system of claim 12, further comprising:
in response to one of the event identifications, modifying a task model based on the plurality of user interactions indicating a task or goal being performed by the user; and
determine, by the adaptation module, the updated command interface of the GUI based on the modified task model.

17. The system of claim 16, wherein modifying the task model further includes associating a sequence of the plurality of user interactions with the task or goal.

18. The system of claim 12, further comprising:
in response to one of the event identifications, modifying a task model based on the plurality of user interactions indicating a task or goal being performed by the user; and
determining, by the adaptation module, the updated command interface of the GUI based on the modified task model.

19. The system of claim 12, further comprising:
monitoring a plurality of interactions with the presented command interfaces in the adapted GUI;
modifying an adaptation model used to adapt the GUI based on an at least one of an efficiency score, changes to a modeled goal, changes to frequently used commands, changes to recently used commands, pattern of use, and changes to task model and the user model, wherein the efficiency score is based on use of the presented command interfaces in the adapted GUI; and
basing future adaptations of the GUI on the modified adaptation model.

20. The system of claim 12, wherein modifying the adaptation model is further based on an efficiency score, the efficiency score based on use of presented command interfaces in the GUI.

21. The system of claim 12, further comprising:
based on the adaptation model, providing a message to the application enabling at least one of an adaptation widget, adaptation canvas, or adaptation message, wherein the message of the adaptation widget enables the application to present the updated command interface by adding or removing a control of the application, an adaptation canvas provides a designated area within the application to present the updated command interface, and the adaptation message provides instructions for the application to present the updated command interface.

22. The system of claim 12, wherein the adaptation module is further configured to determine the updated command interface based on a user trait of the model of the user, including user traits indicating need for dynamic content, directive feedback, and amount of information presented in the GUI.
